(19) United States
(12) Patent Application Publication
(10) Pub. No.: US 2025/0365401 A1
(43) Pub. Date: Nov. 27, 2025

(54) ELECTRONIC DEVICE, METHOD, AND NON-TRANSITORY COMPUTER READABLE STORAGE MEDIUM FOR GENERATING THREE-DIMENSIONAL IMAGE OR THREE-DIMENSIONAL VIDEO USING ALPHA CHANNEL IN WHICH DEPTH VALUE IS INCLUDED

(71) Applicant: SAMSUNG ELECTRONICS CO., LTD., Suwon-si (KR)

(72) Inventors: Jeehae KIM, Suwon-si (KR); Byunghyun AHN, Suwon-si (KR); Byungpo CHOI, Suwon-si (KR); Sungoh KIM, Suwon-si (KR); Donghyun YEOM, Suwon-si (KR)

(73) Assignee: SAMSUNG ELECTRONICS CO., LTD., Suwon-si (KR)

(21) Appl. No.: 19/188,780

(22) Filed: Apr. 24, 2025

Related U.S. Application Data
(63) Continuation of application No. PCT/KR2025/004635, filed on Apr. 4, 2025.

(30) Foreign Application Priority Data
May 21, 2024 (KR) 10-2024-0066119
Sep. 19, 2024 (KR) 10-2024-0126985

(51) Int. Cl. H04N 13/178; H04N 13/00; H04N 13/239; H04N 13/271; H04N 13/275; H04N 13/398

(52) U.S. Cl. CPC H04N 13/178; H04N 13/239; H04N 13/271; H04N 13/275; H04N 13/398; H04N 2013/0081

(57) ABSTRACT

An electronic device includes: memory comprising one or more storage media storing instructions; and at least one processor comprising processing circuitry, wherein the instructions, when executed by the at least one processor individually or collectively, cause the electronic device to: obtain depth information of a visual object, identify, based on the depth information of the visual object, depth values, add the depth values to an alpha channel of an image representing the visual object, and generate the image, and wherein the alpha channel includes the depth values and transparencies of the visual object.

### CROSS-REFERENCE TO RELATED APPLICATIONS

This application is a by-pass continuation application of International Application No. PCT/KR2025/004635, filed on Apr. 4, 2025, which is based on and claims priority to Korean Patent Application No. 10-2024-0066119, filed on May 21, 2024, and to Korean Patent Application No. 10-2024-0126985, filed on Sep. 19, 2024, in the Korean Intellectual Property Office, the disclosures of which are incorporated by reference herein their entireties.

### BACKGROUND

### 1. Field

The present disclosure relates to an electronic device, a method, and a non-transitory computer readable storage medium for generating a three-dimensional image or a three-dimensional video using an alpha channel in which a depth value is included.

### 2. Description of Related Art

In order to provide enhanced user experience, an electronic device has been developed to provide an augmented reality (AR) service that displays information generated by a computer in connection with an external object in the real-world. The electronic device may be a wearable device that may be worn by a user, for example, AR glasses or a head-mounted device (HM D).

The above-described information may be provided as related art for the purpose of helping understanding of the present disclosure. No argument or decision is made as to whether any of the above description may be applied as prior art related to the present disclosure.

### SUMMARY

According to an aspect of the disclosure, an electronic device includes: memory comprising one or more storage media storing instructions; and at least one processor comprising processing circuitry, wherein the instructions, when executed by the at least one processor individually or collectively, cause the electronic device to: obtain depth information of a visual object, identify, based on the depth information of the visual object, depth values, add the depth values to an alpha channel of an image representing the visual object, and generate the image, and wherein the alpha channel includes the depth values and transparencies of the visual object.

According to an aspect of the disclosure, a method of an electronic device, includes: obtaining depth information of a visual object; identifying, using the depth information, depth values; adding the depth values to an alpha channel of an image representing the visual object, and generating the image, wherein the alpha channel includes the depth values and transparencies of the visual object.

According to an embodiment, an electronic device may comprise memory comprising one or more storage media and storing instructions, and at least one processor comprising processing circuitry. The instructions, when executed by the at least one processor individually or collectively, may cause the electronic device to obtain depth information of a visual object. The instructions, when executed by the at least one processor individually or collectively, may cause the electronic device to, using the depth information, identify depth values to be included in an alpha channel representing a transparency of the visual object. The instructions, when executed by the at least one processor individually or collectively, may cause the electronic device to generate an image representing the visual object of which the depth values and transparencies are respectively included in the alpha channel of pixels.

According to an embodiment, a method of an electronic device may be provided. The method may comprise obtaining depth information of a visual object. The method may comprise, using the depth information, identifying depth values to be included in an alpha channel representing a transparency of the visual object. The method may comprise generating an image representing the visual object of which the depth values and transparencies are respectively included in the alpha channel of pixels.

According to an embodiment, a non-transitory computer readable storage medium storing instructions may be provided. The instructions, when executed by an electronic device comprising a display assembly including a plurality of displays, may cause the electronic device to obtain a file including an image representing a visual object. The instructions, when executed by the electronic device, may cause the electronic device to identify, from an alpha channel of pixels of the image, depth values and transparencies of portions of the visual object respectively corresponding to the pixels. The instructions, when executed by the electronic device, may cause the electronic device to, while controlling the display assembly to display the visual object represented based on the transparencies, control the plurality of displays such that the portions displayed on a first display of the plurality of displays are respectively shifted from the portions displayed on a second display of the plurality of displays according to the depth values.

According to an embodiment, an electronic device may comprise a display assembly including a plurality of displays, memory storing instructions and comprising one or more storage mediums, and at least one processor comprising processing circuitry. The instructions, when executed by the at least one processor individually or collectively, may cause the electronic device to obtain a file including an image representing a visual object. The instructions, when executed by the at least one processor individually or collectively, may cause the electronic device to identify, from an alpha channel of pixels of the image, depth values and transparencies of portions of the visual object respectively corresponding to the pixels. The instructions, when executed by the at least one processor individually or collectively, may cause the electronic device to, while controlling the display assembly to display the visual object represented based on the transparencies, control the plurality of displays such that the portions displayed on a first display of the plurality of displays are respectively shifted from the portions displayed on a second display of the plurality of displays according to the depth values.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A and FIG. 1B illustrate an example operation in which an electronic device performs three-dimensional rendering by using an alpha channel of two-dimensional pixels, according to an embodiment;

FIG. 2 illustrates a block diagram of an electronic device according to an embodiment;

FIGS. 3A and 3B illustrate programs executed in an electronic device according to an embodiment;

FIG. 4A and FIG. 4B illustrates a flowchart of an electronic device according to an embodiment;

FIG. 5 illustrates an example operation of an electronic device performing scaling for a depth value.

FIG. 6 illustrates an example operation of an electronic device generating a video based on a key frame;

FIG. 7 illustrates an example operation of an electronic device generating a video indicating a motion of a visual object by using sensor data;

FIG. 8 illustrates an example operation of an electronic device performing three-dimensional rendering on a visual object represented by an image file;

FIG. 9A illustrates an example of a perspective view of an electronic device according to an embodiment;

FIG. 9B illustrates an example of one or more hardware disposed in an electronic device according to an embodiment;

FIG. 10A and FIG. 10B illustrate an example of an exterior of an electronic device according to an embodiment;

FIG. 11 illustrates an example of a block diagram of an electronic device; and

FIG. 12 illustrates an example of a block diagram of an electronic device for displaying an image in a virtual space.

### DETAILED DESCRIPTION

Hereinafter, one or more embodiments of the present disclosure will be described with reference to the accompanying drawings.

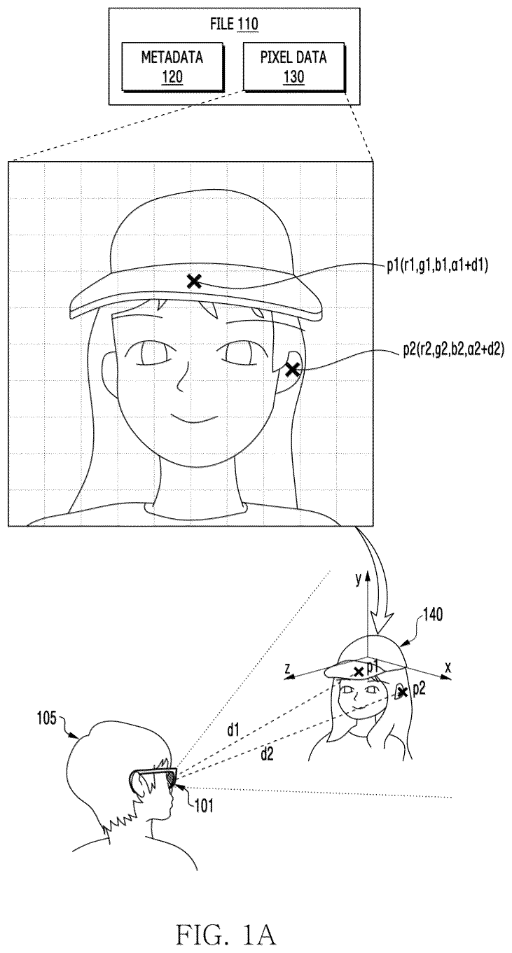

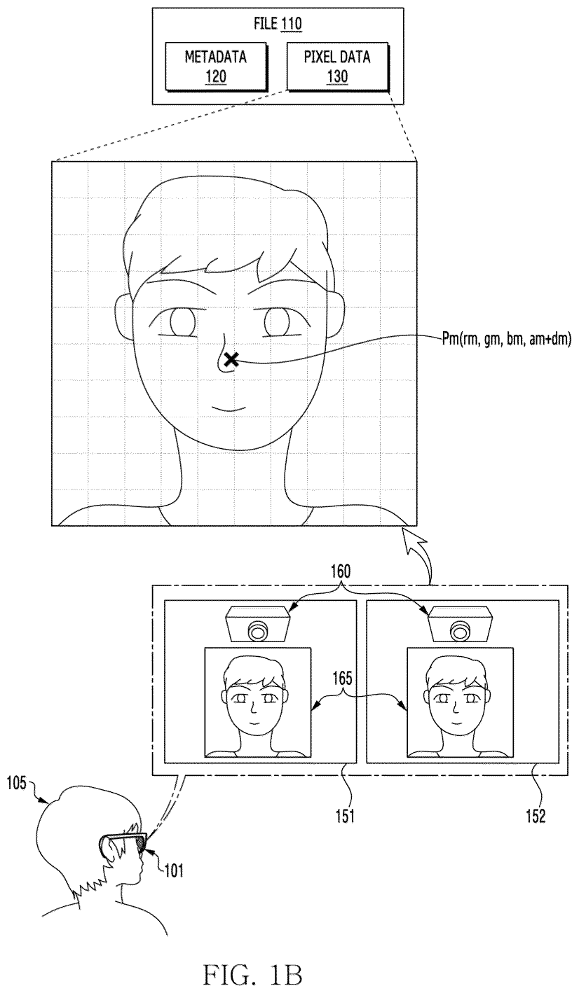

FIGS. 1A and 1B illustrate an example operation in which an electronic device 101 performs three-dimensional rendering using an alpha channel of two-dimensional pixels, according to an embodiment. The electronic device 101 may include a head-mounted display (HM D) wearable on a head of a user 105. The electronic device 101 may be referred to as a HM D device, a headgear electronic device, a glasses-type (or goggle-type) electronic device, a video see-through or visible see-through (V ST) device, an extended reality (X R) device, a virtual reality (VR) device, and/or an augmented reality (AR) device.

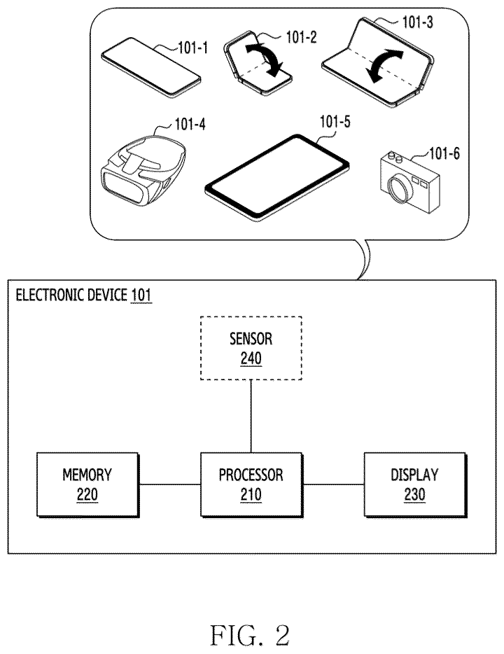

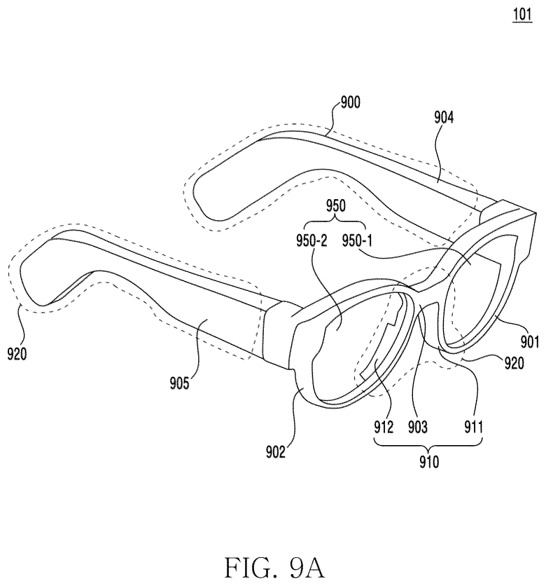

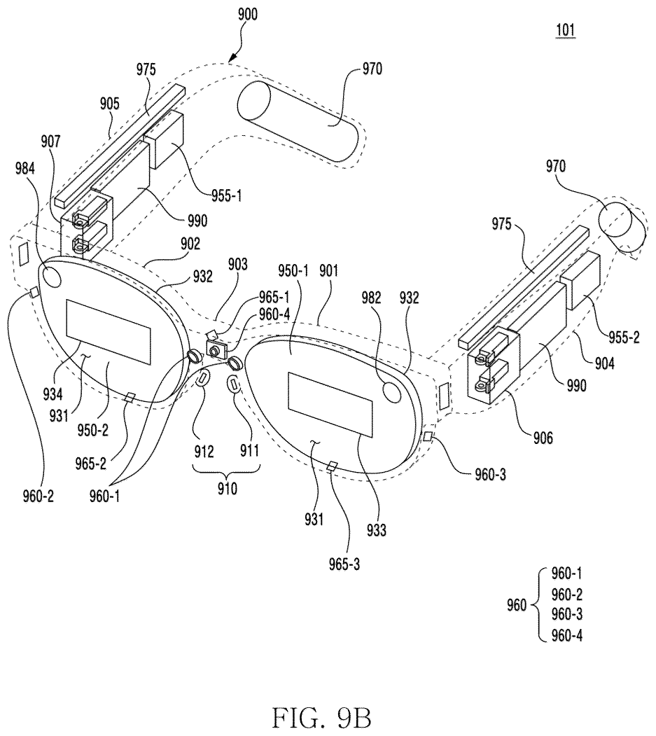

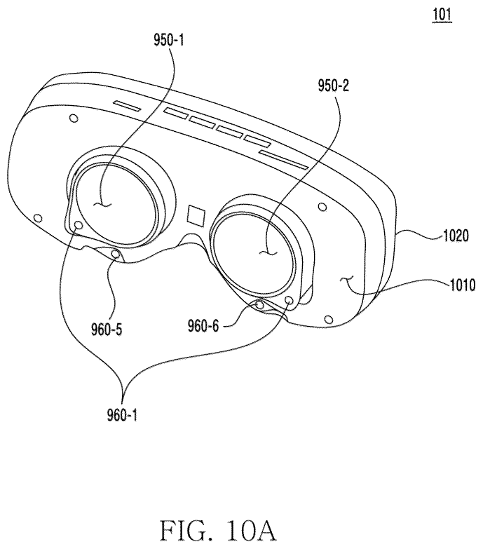

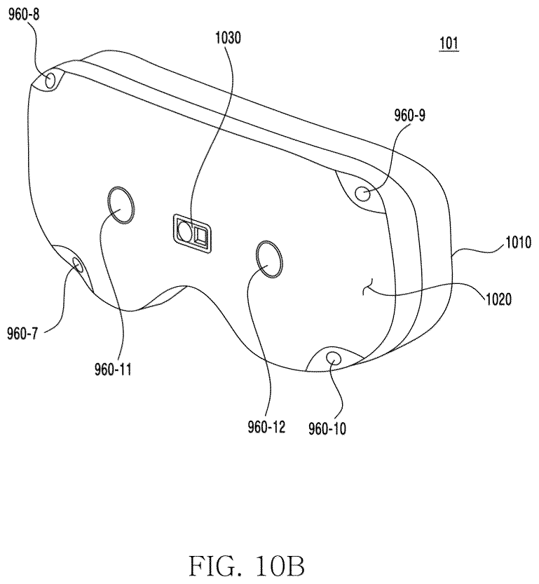

FIG. 1A illustrates an external appearance of the electronic device 101 having a shape of glasses, but embodiments of the disclosure are not limited thereto. For example, the electronic device 101 may include a mobile phone (e.g., a smartphone with a bar shape, and a foldable phone with a flexible display including a bendable portion), a laptop personal computer (PC), a desktop PC, and/or a tablet PC. An example of a hardware configuration included in the electronic device 101 having various form factors described above is exemplarily described with reference to FIG. 2. FIG. 9A, FIG. 9B, FIG. 10A, or FIG. 10B describes an example of a structure of the electronic device 101 wearable on the head of the user 105. Because the electronic device 101 may be wearable on the head of the user 105, the electronic device 101 may be referred to as a wearable device. The electronic device 101 may include an accessory (e.g., a strap) for attaching to the head of the user 105.

Referring to FIG. 1A, the electronic device 101 may ‘three-dimensionally’ display a virtual object 140. That is, the virtual object 140 may be displayed in three dimensions or in two and a half dimensions (or pseudo-three dimensions). Through the disclosure, the term “three-dimensionally” indicates the three dimensions or the ‘two and a half’ dimensions (pseudo-three dimensions).

The virtual object 140 may be described as a graphic object defined using a point cloud, a vertex, and/or a mesh. In the present disclosure, the virtual object 140 may be referred to as a visual object, a visual element, and/or a virtual element. According to an embodiment, the electronic device 101 may display a three-dimensional image and/or a three-dimensional video indicating the virtual object 140 to the user 105 (e.g., the user 105 wearing the electronic device 101). For example, the electronic device 101 may display, on a display, an image of the virtual object 140 viewed from a virtual camera spaced apart from the virtual object 140 in a virtual space including the virtual object 140.

FIG. 1A illustrates a state of the electronic device 101 displaying the example virtual object 140, referred to as an avatar, an AR emoticon, a virtual reality (VR) emoticon, an AR emoji, and/or a VR emoji. The avatar may be generated to represent the user 105 (or a user linked with the avatar) of the electronic device 101. The avatar may be customized by the user 105 of the electronic device 101. Using the avatar representing the user 105, the electronic device 101 may execute a function associated with an online service (e.g., metaverse, a social network service (SNS), and/or a service based on a digital twin). For example, the electronic device 101 may register an avatar representing a reaction of the user 105 (e.g., a facial expression and/or an emotional reaction of the user 105) to content (e.g., news, a post, an article, and/or a (text) message) provided through the online service with the online service.

In an embodiment, the electronic device 101 may support a selfie function based on the virtual object 140. For example, while being worn by the user 105, the electronic device 101 may detect a motion of the user 105 (e.g., a motion of the head, a hand, and/or eyes or a motion of a face, which is referred to as the facial expression, of the user 105). The electronic device 101 may provide a user experience such as the virtual object 140 simulating the motion of the user 105, by changing a shape and/or a position of the virtual object 140 using the detected motion. The electronic device 101 may support a function of capturing the virtual object 140 reflecting the motion of the user 105. The capture may be performed based on the virtual camera defined in the virtual space including the virtual object 140. For example, the electronic device 101 may generate or store an image and/or a video representing the virtual object 140 having the shape and/or the position based on the motion of the user 105. The image and/or the video may be stored in a file 110.

Referring to FIG. 1A, the file 110 may include metadata 120 and pixel data 130. Various information describing the pixel data 130 and/or the file 110 may be stored in the metadata 120, for example, based on a format such as an ‘exchangeable image file format’ (EXIF). The pixel data 130 may include information on pixels of the image and/or the video included in the file 110. When generating the file 110 indicating the image and/or the video representing the virtual object 140, the electronic device 101 may generate the pixel data 130 and the metadata 120 indicating the image and/or the video.

For example, the electronic device 101 may generate raw data based on two-dimensional pixels representing a two-dimensional projection of the virtual object 140. The raw data may include a color, a transparency (or opacity or an alpha value), and a depth value of each of the pixels. For example, when the color is represented based on three primary colors of red, green, and blue, the electronic device 101 may obtain five attributes (e.g., brightness (or luminance, intensity, strength) of each of the three primary colors indicating the color, a transparency, and a depth value) for each of the pixels. For example, the raw data indicating an image with a width of w and a height of h may include w×h×5 values. In a case that each of the values is represented in a binary number of 8 bits (or 1 byte), the electronic device 101 may generate raw data having a size of w×h×5×8 bits.

According to an embodiment, the electronic device 101 may generate or obtain the pixel data 130 from the raw data representing the virtual object 140 based on the pixels having the brightness of each of the three primary colors, the transparency, and the depth value. The pixel data 130 may be set to have four attributes (or elements, or channels) for each of the pixels. The four attributes (or channels) may include a red attribute (or a red channel) indicating brightness of red light included in the color of a pixel, a blue attribute (or a blue channel) indicating brightness of blue light included in the color of a pixel, a green attribute (or a green channel) indicating brightness of green light included in the color of a pixel, and/or an alpha attribute (or an alpha channel) indicating the transparency of a pixel.

In a case that each of values of the attributes is represented by the binary number of 8 bits, the values may be included in an integer range of 0 to 255. In a case that each of the values is represented by the binary number of 8 bits, the electronic device 101 may indicate attributes (e.g., the color, the transparency, and the depth value) of one pixel by using 32 bits (=8 bits×4). For example, the pixel data 130 indicating an image with a width of w and a height of h may have a size of w×h×32 bits. Embodiments of the disclosure are not limited thereto. For example, the electronic device 101 may generate the pixel data 130 having a size less than a size of w×h×32 bits by applying a compression algorithm (or an encoding algorithm). The pixel data 130 to which the compression algorithm is applied may have the size of less than w×h×32 bits.

According to an embodiment, the electronic device 101 may generate the pixel data 130 in which only four attributes (e.g., the brightness of each of the three primary colors and the transparency) are set to be assigned to one pixel for compatibility. The electronic device 101 may generate the pixel data 130 that further includes the depth value of the pixel while having compatibility, by coupling and/or encoding the depth value with a preset attribute (e.g., an attribute set to have the transparency assigned) among the four attributes.

FIG. 1A illustrates values included (or compressed or decoded) in the pixel data 130 and corresponding to pixels p1 and p2. For example, the electronic device 101 may insert or add a set r1, g1, b1, a1+d1 of values indicating the pixel p1 into the pixel data 130. For example, the electronic device 101 may record or embed a set r2, g2, b2, a2+d2 of values indicating the pixel p2 from the pixel data 130. Herein, ‘+’ may indicate a concatenation of bits. In the present disclosure, a concatenation (or a concatenated calculation) of a first value and a second value may mean a calculation of outputting a third value (e.g., a concatenated value) in which the first value and the second value are connected in series by performing a bit calculation such as a shift calculation. For example, the concatenation between a first value 1011(2) and a second value 0101(2) may mean a calculation of outputting a third value 10110101(2) including the first value and the second value sequentially from a ‘most significant bit’ (MSB). A bit number of the third value may correspond to a sum of bit numbers of the first value and the second value. The electronic device 101 may obtain or identify the first value and the second value from the third value by performing division and/or parsing for the third value.

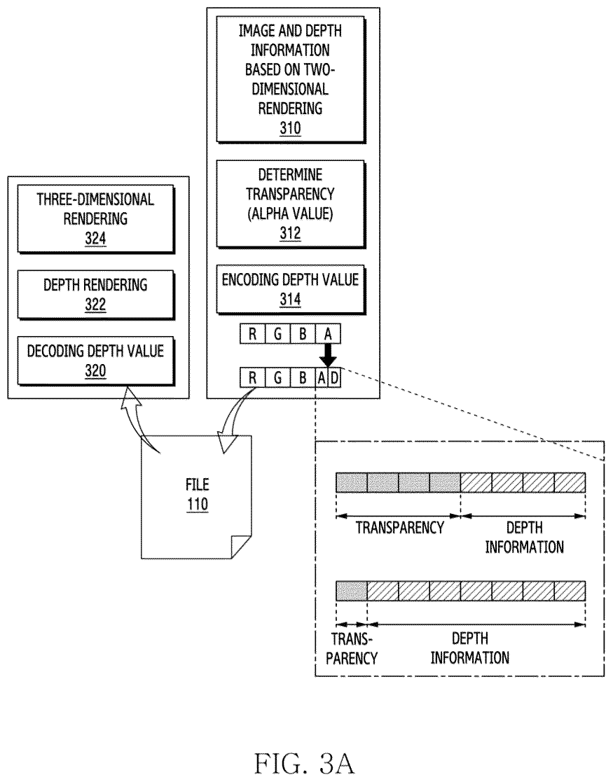

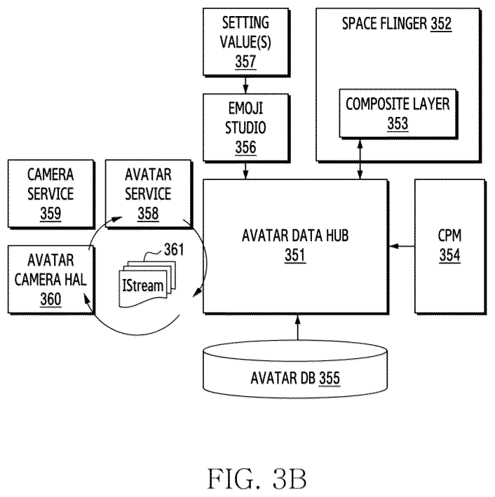

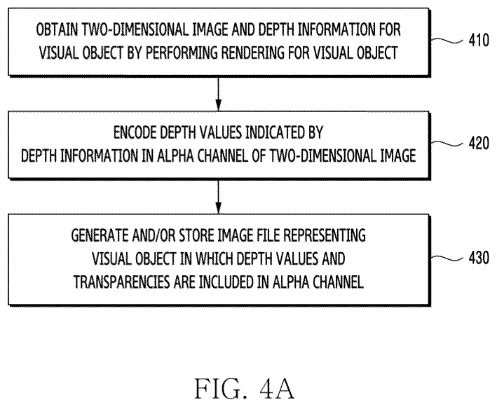

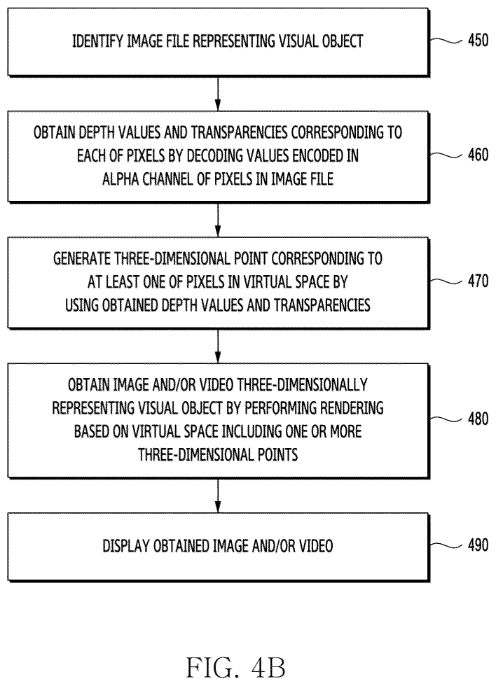

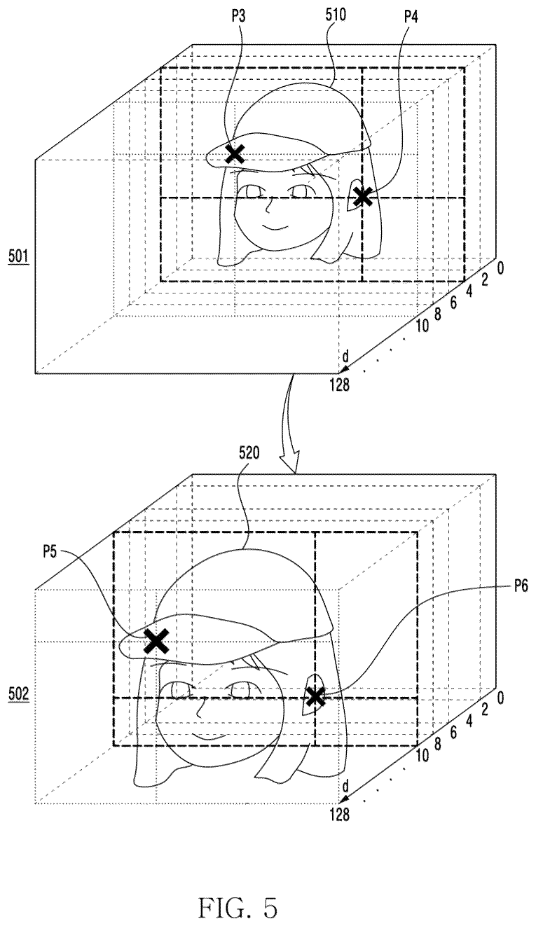

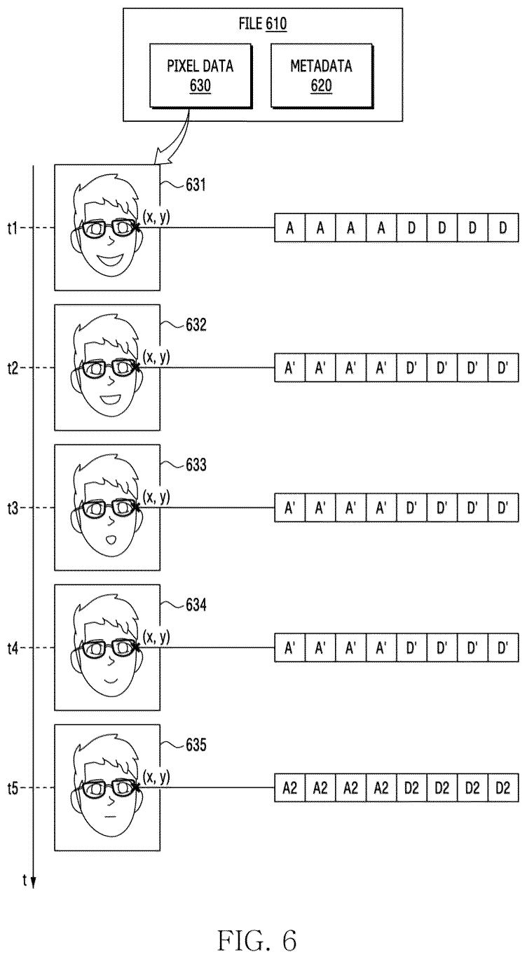

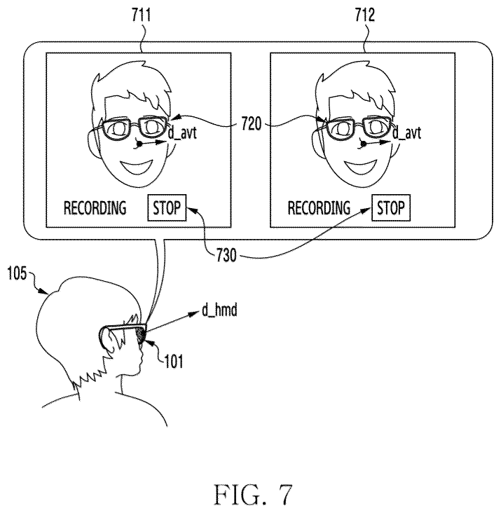

For example, the electronic device 101 may generate or obtain the pixel data 130 including the set r1, g1, b1, α1+d1 including a concatenated value of a transparency a1 and a depth value d1 having a size of 8 bits, together with 8-bit values r1, g1, and b1, as information (or vector) corresponding to the pixel p1. FIG. 3A, FIG. 3B, FIG. 4A, FIG. 5, FIG. 6, or FIG. 7 describes an example operation in which the electronic device 101 according to an embodiment generates the pixel data 130 and the file 110 including the pixel data 130.

As described above, in an embodiment, the electronic device 101 generates the pixel data 130 and the file 110 including the pixel data 130, but embodiments of the disclosure are not limited thereto. For example, the electronic device 101 may display the virtual object 140 from the file 110. For example, the electronic device 101 may obtain the color, the transparency, and/or the depth value of each of the pixels by decompressing (or decoding) the pixel data 130.

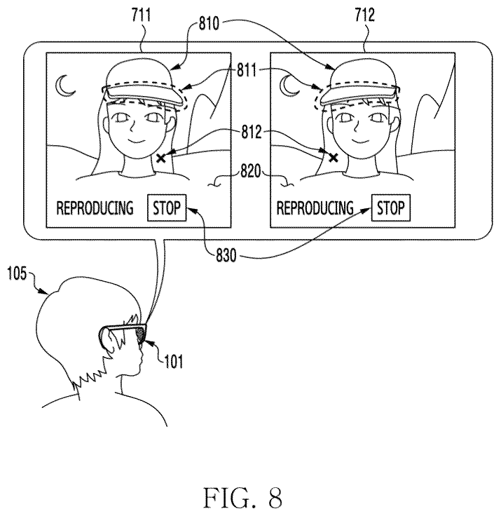

For example, the electronic device 101 identifying four values r1, g1, b1, and α1+d1 for the pixel p1 from the pixel data 130 may display the pixel p1 so that the pixel p1 having a color of r1, g1, and b1 is recognized as having a depth (or a distance) d1 from the user 105 wearing the electronic device 101. For example, the electronic device 101 may create a sense of a distance (e.g., a sense of a distance corresponding to the depth d1) of the user 105 with respect to the pixel p1, by adjusting positions at which the pixel p1 is visible in each of two eyes of the user 105, based on a binocular parallax. Similarly, the electronic device 101 identifying four values r2, g2, b2, and a2+d2 for the pixel p2 may display the pixel p2 having a color of r2, g2, and b2 at a position having a binocular parallax corresponding to a depth d2. FIG. 4B or FIG. 8 describes an example operation of the electronic device 101 displaying and/or visualizing the virtual object 140 from the file 110.

FIG. 1B illustrates an example state of the electronic device 101 performing a selfie function. The electronic device 101 worn on the head of the user 105 may include displays 151 and 152 arranged to face two eyes of the user 105. The electronic device 101 may display a three-dimensional image 165 for the user 105 wearing the electronic device 101 on the displays 151 and 152. The pixels of the image 165 may have positional differences (e.g., a positional difference associated with the binocular parallax) in each of the displays 151 and 152. Based on the positional differences, the user 105 wearing the electronic device 101 may recognize that the image 165 represents their face three-dimensionally.

The electronic device 101 may display a virtual object 160 (e.g., a virtual camera and/or a virtual object referred to as a view point) for adjusting a direction of the face of the user 105 represented through the image 165 on the displays 151 and 152. The electronic device 101 may receive an input for moving the virtual object 160 based on a hand gesture of the user 105, a gaze direction (or information indicating the gaze direction) of the user 105, a touch input on the electronic device 101 (or a remote controller connected to the electronic device 101), and/or a voice input based on a speech. The electronic device 101 receiving the input may change a position of the virtual object 160 within the displays 151 and 152. The electronic device 101 receiving the input may at least partially change the image 165 based on the changed position of the virtual object 160. For example, the electronic device 101 may display the image 165 simulating the face of the user 105 viewed from a virtual position represented by the virtual object 160.

In a state of FIG. 1B displaying the image 165, the electronic device 101 may receive an input (e.g., a photographing input) for capturing the image 165. The electronic device 101 receiving the input may generate or store the file 110 including the pixel data 130 and the metadata 120. The pixel data 130 may include information on colors of pixels included in the image 165. The pixel data 130 may further include information (e.g., the depth value) for three-dimensionally displaying the image 165. FIG. 1B illustrates a set rm, gm, bm, am+dm of values indicating a pixel Pm of the pixel data 130. The set may identify or extract brightness rm, gm, and bm of three primary colors included in a color of the pixel Pm, and a value am+dm in which a transparency and a depth value of the pixel Pm are encoded. For example, five types of information (e.g., brightness values of each of the three primary colors, the transparency, and the depth value) may be encoded in four values included in the set.

As described above, the electronic device 101 according to an embodiment may insert a depth value to a transparency among red, green, blue, and the transparency and then generate the pixel data 130 and the file 110 that are readable in another electronic device extracting red, green, blue, and a transparency, and support three-dimensional rendering of the virtual object 140. The electronic device 101 may generate or store the pixel data 130 including both the transparency and the depth value based on a concatenation. The electronic device 101 may provide an immersive user experience to the user 105 wearing the electronic device 101, by three-dimensionally rendering the virtual object 140 using the pixel data 130.

FIG. 2 illustrates a block diagram of an electronic device 101 according to an embodiment. Referring to FIG. 2, the electronic device 101 may be one of various types of electronic devices such as smartphones with various form factors (e.g., a smartphone 101-1 of a bar type, smartphones 101-2 and 101-3 of a foldable type, or a smartphone of a slidable (or rollable) type), a tablet personal computer (PC) 101-5, a HM D device 101-4, a digital camera 101-6, a watch, a cellular phone, a laptop PC, a desktop PC, and/or other similar computing devices.

In an embodiment, the electronic device 101 may be referred to as a mobile device, user equipment (UE) (or a user terminal), a multifunctional device, a portable communication device, a portable device, or a server. A form factor of the electronic device 101 is not limited to example form factors illustrated in FIG. 2. For example, the electronic device 101 may be included as an electronic control unit (ECU) in a vehicle (e.g., an electric vehicle (EV)). For example, the electronic device 101 may have a shape suitable for displaying an image and/or a video.

Referring to FIG. 2, according to an embodiment, the electronic device 101 may include a processor 210 and/or memory 220. The electronic device 101 may further include a display 230 and/or a sensor 240. The processor 210 may be electrically and/or operatively coupled to the memory 220 and/or the display 230. Electronic components being electrically coupled with each other may include a state in which a wired signal path (or connection for wireless communication) for transmission of a signal is established between the electronic components. Electronic components being operatively coupled with each other may include a state in which the electronic components are directly coupled (or a state in which the electronic components are indirectly coupled) so that another electronic component is controlled by any one of the electronic components.

Referring to FIG. 2, the processor 210 of the electronic device 101 may include circuitry (e.g., processing circuitry and/or core) for performing a calculation (e.g., an arithmetic calculation and/or a logical calculation) for data. A binary code (e.g., instruction) indicating the calculation may be inputted to the processor 210. The processor 210 may include a central processing unit (CPU), a graphic processing unit (GPU), and/or a neural processing unit (NPU). The processor 210 may be referred to as an application processor (AP) and/or a system on a chip (SoC). The processor 210 may have a structure (e.g., a multi-core structure based on a combination of a plurality of core circuitry such as a dual core, a quad core, a hexa core, or an octa core) for simultaneously loading (or fetching) and/or executing a plurality of instructions. In the electronic device 101 including at least one processor including the processor 210, the at least one processor may perform operations of the present disclosure individually or collectively. For example, the at least one processor may perform operations of FIG. 4A and/or FIG. 4B individually and/or collectively by executing instructions stored in the memory 220.

The memory 220 of FIG. 2 may include circuitry for storing data (or instructions) inputted to the processor 210 or outputted from the processor 210. The memory 220 may include volatile memory such as random-access memory (RAM) and/or non-volatile memory such as read-only memory (ROM). The non-volatile memory may be referred to as storage. The volatile memory may include, for example, at least one of dynamic RAM (DRAM), static RAM (SRAM), cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disc, a solid state drive (SSD), and an embedded multimedia card (eM M C). The memory 220 may include one or more storage media (e.g., the volatile memory and/or the non-volatile memory as described above) positioned in a distributed manner in the electronic device 101. The processor 210 of the electronic device 101 may execute instructions of the memory 220 in the electronic device 101 to perform a function and/or an operation (e.g., the operations of FIGS. 4A and/or 4B) indicated by the instructions.

The display 230 of the electronic device 101 may include circuitry for visualizing information provided from the processor 210. The display 230 may include a liquid crystal display (LCD), a plasma display panel (PDP), and/or light emitting diodes (LEDs). The LED may include an organic LED (OLED). For example, the display 230 may include electronic paper. For example, in a case that the electronic device 101 includes a lens for penetrating external light (or ambient light), the display 230 may include projector (or a projection assembly) for projecting light onto the lens. The display 230 may be referred to as a display panel and/or a display module. The number of displays 230 included in the electronic device 101 may vary according to an embodiment. For example, the electronic device 101 having a shape of the HMD device 101-4 may include displays positioned over each of two eyes of a user when the HM D device 101-4 is worn by the user (e.g., the user 105 of FIG. 1A and/or FIG. 1B). A combination of the displays included in the HM D device 101-4 may be referred to as a display assembly.

In an embodiment, a display area (or an active area) of the display 230 may include an area in which light is emitted, formed by pixels (e.g., activated pixels) of the display 230. The display 230 may include a sensor (e.g., a touch sensor) for detecting an external object (e.g., a finger of the user) on the display 230. The sensor may be included in the display 230 as a shape of a panel (e.g., a touch sensor panel (TSP)).

In an embodiment, the sensor 240 of the electronic device 101 may generate electronic information that may be processed by the processor 210 and/or the memory 220 from non-electronic information associated with the electronic device 101. For example, the sensor 240 may include a global positioning system (GPS) sensor for detecting a geographic location of the electronic device 101. In addition to the GPS method, the sensor 240 may generate information indicating the geographic location of the electronic device 101 based on a global navigation satellite system (GNSS) such as, for example, galileo, and beidou (compass). The information may be stored in the memory 220, processed by the processor 210, and/or transmitted to another electronic device distinct from the electronic device 101 through communication circuitry. In an embodiment, the sensor 240 of the electronic device 101 may include an image sensor for obtaining an image and/or a video. In an embodiment, the electronic device 101 has the shape of the HM D device 101-4 and the electronic device 101 may include a plurality of image sensors configured to obtain images with respect to two eyes, a facial expression, a hand gesture, and/or an external environment of the user wearing the HM D device 101-4.

According to an embodiment, the electronic device 101 may generate an image and/or a video representing an avatar (e.g., the virtual object 140 of FIG. 1A) corresponding to the user using information obtained from the sensor 240 as described above with reference to FIG. 1A and/or FIG. 1B. The image and/or the video may be stored in a file (e.g., the file 110 of FIG. 1A and/or FIG. 1B). The image and/or the video may be stored based on a format set to assign four numerical values (e.g., a binary number and/or a binary code) to one pixel in the file. The numerical values may each correspond to four channels respectively indicating attributes of a pixel. The processor 210 of the electronic device 101 according to an embodiment may generate or load a file, which is set to represent both a transparency and a depth value using an alpha channel, among the channels.

FIG. 3A or FIG. 3B describes an example operation of the electronic device 101 that generates or loads the file, which is set to represent both the transparency and the depth value using the alpha channel.

FIGS. 3A and 3B illustrate programs executed in an electronic device according to an embodiment. The electronic device 101 of FIG. 1A, FIG. 1B, and/or FIG. 2 may include the electronic device of FIG. 3A to FIG. 3B. The programs illustrated in FIG. 3A to FIG. 3B may be executed by the electronic device 101 and/or the processor 210 of FIG. 2.

Referring to FIG. 3A, the electronic device may obtain an image (e.g., a two-dimensional image) based on two-dimensional rendering of the virtual object and/or depth information corresponding to the image (e.g., an operation 310) by rendering a virtual object (e.g., the virtual object 140 of FIG. 1A). For example, the depth information may indicate depth values of each of pixels of an image. The depth information may be determined using a reference value stored (in advance) in the electronic device. The reference value may be determined (empirically) using an appropriate depth value to three-dimensionally display an image to be reproduced through a file 110. The electronic device may obtain the depth information by changing the reference value according to information (e.g., information indicating a position, a posture, and/or a shape of a hand and/or a face of a user wearing the electronic device) detected using a sensor of the electronic device.

In an operation 312, the electronic device may determine or calculate transparencies (e.g., alpha values) of pixels of the image of the operation 310. A transparency may be determined using a reference transparency stored (in advance) in the electronic device. For example, the reference transparency may be minimal at a center of the image and may increase as moving away from the center of the image. In other words, the reference transparency may indicate an image in which a central area is opaque and a peripheral area is transparent. In an operation 314, the electronic device may encode depth values indicated by the depth information in an alpha channel A representing a transparency of the virtual object by using the depth information of the operation 310. For example, the electronic device may identify depth values to be included in the alpha channel A representing the transparency of the virtual object by using the depth information of the operation 310. The electronic device may generate an image representing the virtual object of which the depth values and the transparencies are respectively included in the alpha channel A of the pixels. The electronic device may generate or store the file 110 including pixel data (e.g., the pixel data 130 of FIG. 1A) representing the image.

In an embodiment, information (e.g., a flag value) indicating that a depth value is included in the alpha channel A may be included in a file header and/or metadata (e.g., the metadata 120 of FIGS. 1A and/or 1B) of the file 110. The information may indicate a length (e.g., a bit number) and/or a position of the depth value in the alpha channel A. In order to maintain compatibility, a default value for recognizing a transparency through the alpha channel A may be set in the information.

Referring to FIG. 3A, among bits of 8 bits included in the alpha channel A, bits corresponding to each of a transparency and depth information are exemplarily described. The electronic device may identify a range of the depth values indicated by the depth information of the operation 310. According to the range, the electronic device may determine a bit number to be occupied to represent the depth values in the alpha channel A, and a bit number to be occupied to represent the transparencies. The electronic device may determine a ratio of bit numbers to indicate each of the transparency and the depth value according to a feature (e.g., a range and/or importance) of the transparency and/or importance of the depth value. The ratio may increase or decrease according to the importance of the transparency and the depth value. Based on the determination, the electronic device may generate an image including the depth values and the transparencies in the alpha channel A, and/or the file 110 indicating the image.

For example, based on determining that the depth values are represented by bits of a first bit number (e.g., 4), the electronic device may generate an image including the depth values represented by the bits of the first bit number using the depth information and transparencies represented by bits of a second bit number (e.g., 4=8-4) subtracted from the total number of bits (e.g., 8) included in the alpha channel A by the first bit number. For example, in the alpha channel A of one pixel, a transparency indicated in four bits and a depth value indicated in four bits may be concatenated. In the example, among the 8 bits of the alpha channel A, an MSB and three bits adjacent to the M SB may indicate the transparency, and the remaining four bits may indicate the depth value. For example, a sequence (e.g., a bit sequence) of the bits indicating the depth value may be positioned after a least significant bit (LSB) of a sequence of the four bits indicating the transparency. Embodiments of the disclosure are not limited thereto. For example, among the 8 bits of the alpha channel A, the LSB and three bits adjacent to the LSB may indicate the transparency, and the remaining four bits may indicate the depth value.

For example, based on determining that the depth values are represented by bits of a third bit number (e.g., 7) greater than the first bit number, the electronic device may generate an image including the depth values represented by the bits of the third bit number using the depth information and transparencies represented by bits of a fourth bit number (e.g., 1=8−7) subtracted from the total number (e.g., 8) by the third bit number. For example, in a case that the image obtained based on the operation 310 includes only a fully transparent area and a fully opaque area, since transparencies of all pixels may be indicated by only two values, the electronic device may indicate the transparency using only one bit and may indicate the depth value using the remaining seven bits. In the example, the sequence (e.g., the bit sequence) of the bits indicating the depth value may be positioned after the bit indicating the transparencies, in the alpha channel A of one pixel. Embodiments of the disclosure are not limited thereto. In an embodiment, in the alpha channel A of one pixel, the bit sequence indicating the depth value may be positioned before the M SB of the bit sequence (or bit(s)) indicating the transparency.

In an embodiment, since bits indicating the depth value are positioned in a portion of an alpha channel including the LSB, a size of a concatenated value of the alpha channel may be associated with the transparency among the transparency and the depth value. For example, another electronic device that may not obtain a depth value from the alpha channel may determine the concatenated value as a transparency. In a case that the concatenated value is determined as the transparency, since the bits indicating the depth value are positioned in the portion of the alpha channel including the LSB, an order of magnitude of transparencies of pixels may match an order of magnitude of transparencies included in the concatenated value, even though the concatenated value further includes the depth value.

In an embodiment, the electronic device may determine the transparency and positions and/or sizes of the depth value in the alpha channel either collectively for all pixels or independently for the pixels. When generating the file 110 indicating a video, the electronic device may collectively set the transparency and the positions and/or the sizes of the depth value in the alpha channel of image frames included in the video.

Embodiments of the disclosure are not limited thereto, and in the image frames, the transparency and the positions and/or the sizes of the depth value in the alpha channel may be different from each other.

In an embodiment, the electronic device generating pixel data indicating pixels in which a concatenated value of the transparency and the depth value are positioned in the alpha channel may generate or obtain metadata (e.g., the metadata 120 of FIGS. 1A and/or 1B) including information for extracting the transparency and the depth value from the concatenated value. For example, the electronic device may generate metadata indicating a bit number in the alpha channel, which is reserved to indicate each of the depth values. In an embodiment, the alpha channel has a preset bit number (e.g., 8) and the electronic device may generate metadata indicating a ratio between the number of bits corresponding to the depth value and the number of bits corresponding to the transparency. For example, the electronic device may generate metadata indicating digits of one or more bits occupied by the depth value in the alpha channel. For example, the electronic device may generate metadata indicating a bit number in the alpha channel reserved to indicate a transparency and/or digits of one or more bits indicating the transparency. The electronic device may generate a file including the metadata and pixel data representing the image.

In an embodiment, the electronic device generates the metadata indicating an attribute (e.g., the transparency and/or the position and/or the size of the depth information in the concatenated value) of the concatenated value of the alpha channel, but embodiments of the disclosure are not limited thereto.

For example, since a fully transparent pixel (e.g., a pixel with a maximum transparency) may not display any color, the electronic device may indicate the attribute of the concatenated value by using bits (e.g., 24 bits representing a red channel, a green channel, and a blue channel) for representing a color in the pixel. For example, when generating an image including a first area corresponding to a virtual object and a second area surrounding the first area, transparencies of pixels of the image corresponding to the second area may have a maximum transparency (e.g., a binary number indicating 100% transparency). In the above example, the electronic device may insert (e.g., the concatenated value of the depth value and the transparency) depth values and transparencies to an alpha channel of pixels corresponding to the first area. In the above example, the electronic device may insert bit numbers (or digits) of the depth values and/or the transparencies inserted to the alpha channel of the pixels corresponding to the first area to pixels corresponding to the second area.

In an embodiment, a range and a step of a depth value represented by the depth information may be adjusted. For example, in a case that a maximum value of a depth value of a specific image is 10, and bits (e.g., bits indicating natural numbers of 0 to 63) of 6 bits are used to represent the depth value, the electronic device may set depth levels represented by the bits in units of 10/64=0.156. The electronic device may generate the file 110 in which the depth information determined in a range of 0 to 10 is represented in detail, by changing the unit of the depth level.

Referring to FIG. 3A, when displaying an image and/or a video of a virtual object indicated by the file 110, the electronic device may perform at least one of operations 320, 322, and 324. In operation 320, the electronic device may decode a depth value included in the file 110. For example, the electronic device may extract, identify, or parse the depth value from an alpha channel of pixels included in pixel data of the file 110. For example, the electronic device may obtain or identify depth values corresponding to each of the pixels by dividing concatenated values included in the alpha channel of the pixels. In operation 322, the electronic device may perform depth rendering of the image and/or the video using the decoded depth values. The depth rendering may include an operation of determining depth values of each of pixels of a two-dimensional image and/or a two-dimensional video of the file 110. In operation 324, the electronic device may perform three-dimensional rendering for the two-dimensional image and/or the two-dimensional video using the depth values determined based on the depth rendering. Based on a transparency obtained from the concatenated value of the alpha channel, the three-dimensional rendering may include an operation of displaying a pixel having a color indicated by the red channel, the green channel, and the blue channel according to a binocular parallax corresponding to a depth value obtained from the concatenated value.

According to an embodiment, the electronic device may insert a depth value into the file 110 without changing a data structure of the file 110 based on the red channel, the green channel, the blue channel, and the alpha channel. Since the data structure of the file 110 is not changed, an operation (e.g., an operation of identifying a pixel based on the red channel, the green channel, and the blue channel) included in a pipeline for three-dimensional rendering may be at least partially reused or maintained. Since the data structure is not changed, the electronic device may generate or store the file 110 further including a depth value without increasing a size of the file 110.

FIG. 3B illustrates programs executed by the electronic device to generate and/or execute (e.g., display an image and/or a video indicated by the file 110) the file 110. The programs executed by the electronic device may include an avatar data hub 351, a space flinger 352, a ‘composition presentation manager’ (CPM) 354, an emoji studio 356, an avatar service 358, a camera service 359, an avatar camera ‘hardware abstraction layer’ (HAL) 360, or any combination thereof. In the electronic device, data (e.g., an avatar DB 355 and/or a setting value(s) 357) used to execute the programs may be stored. The electronic device may generate or obtain a bitstream (e.g., an IStream 361) representing an image and/or a video, which may be displayed on a display or stored in a file (e.g., the file 110 of FIG. 1A and/or FIG. 1B), by executing the programs.

Referring to FIG. 3B, the avatar data hub 351 executed by the electronic device may be referred to as an avatar provider (or provider). The electronic device executing the avatar data hub 351 may perform two-dimensional rendering for an avatar (e.g., the virtual object 140 of FIG. 1A) to a two-dimensional buffer (e.g., a composite layer 353). In an embodiment, in order to maintain compatibility, the avatar HAL 360 may be configured to perform rendering for the avatar. The electronic device may generate the bitstream (e.g., the IStream 361) by performing the rendering using the avatar HAL 360. The electronic device executing the avatar data hub 351 may obtain depth information on the avatar. The electronic device may obtain the depth information by using information on the avatar stored in the avatar DB 355. The electronic device may obtain or generate pixel data (e.g., the pixel data 130 of FIG. 1A and/or FIG. 1B) in which a concatenated value of a depth value and a transparency is included in an alpha channel, by coupling (e.g., coupling based on quantization) transparencies of pixels of a two-dimensional image of the avatar indicated by the two-dimensional buffer, and depth values indicated by the depth information. The pixel data may be stored in an image buffer assigned to memory (e.g., the memory 220 of FIG. 2).

The avatar data hub 351 may include a stream interface for transmitting the image buffer to a virtual camera. Through the stream interface, the electronic device may generate (e.g., rendering) the image stream (IStream 361) representing the avatar. The avatar data hub 351 may include a resource manager managing information and/or a resource used for rendering the avatar. The avatar data hub 351 may be configured to provide the resource, an event associated with the avatar, information (e.g., information tracked by the sensor 240 of FIG. 2) tracked for rendering the avatar, and/or an audio signal representing a sound of the avatar.

According to an embodiment, when the electronic device performs rendering of the avatar based on a file (e.g., the file 110 of FIG. 1A and/or FIG. 1B), the electronic device may generate or obtain an image and/or a video for the avatar to be displayed on the display by using the composite layer 353. For example, the space flinger 352 may generate the composite layer 353 by using information on other layers managed by the CPM 354 and displayed by the electronic device. When the electronic device performs rendering for the avatar, depth information and/or depth values may be further included in the composite layer 353. For example, a concatenated value of a transparency and a depth value may be included in an alpha channel of pixels in the composite layer 353. The electronic device may three-dimensionally display a two-dimensional image and/or a two-dimensional video of the avatar represented by the composite layer 353, by using the concatenated value.

FIG. 4A and FIG. 4B illustrate a flowchart of an electronic device according to an embodiment. The electronic device 101 of FIG. 1A, FIG. 1B, and/or FIG. 2 may include the electronic device of FIG. 4A and FIG. 4B. An operation of FIG. 4A and FIG. 4B may be performed by the electronic device 101 and/or the processor 210 of FIG. 2. An order of operations illustrated in FIG. 4A and FIG. 4B is not limited to an order illustrated in FIG. 4A and FIG. 4B. For example, the operations illustrated in FIG. 4A and FIG. 4B may be performed in an order different from the order of the operations illustrated in FIG. 4A and FIG. 4B. For example, at least two of the operations illustrated in FIG. 4A and FIG. 4B may be performed substantially simultaneously.

Referring to FIG. 4A, in operation 410, the electronic device according to an embodiment may obtain a two-dimensional image and depth information for a visual object (e.g., the virtual object 140 of FIG. 1A and/or FIG. 1B) by performing rendering for the visual object. For example, the electronic device may obtain or generate a two-dimensional image for the visual object disposed in a three-dimensional virtual space. The two-dimensional image may indicate a shape (or an exterior) of the visual object viewed from a virtual camera disposed in the virtual space. The two-dimensional image may indicate the visual object and a shape of the virtual space surrounding the visual object. Pixels of the two-dimensional image may indicate shapes of portions of the virtual space corresponding to each of the pixels based on a color and a transparency. The two-dimensional image of the operation 410 may be referred to as a ‘Red-Green-Blue-Alpha’ (RGBA) image in terms of including pixels based on red, green, blue, and a transparency (e.g., a transparency referred to as an alpha value).

The depth information of the operation 410 may indicate depth values of each of the pixels. For example, the depth values may indicate distances between the portions of the virtual space corresponding to each of the pixels, and the virtual camera. The depth information may be referred to as a depth map for the two-dimensional image of the operation 410.

Referring to FIG. 4A, in operation 420, the electronic device according to an embodiment may encode the depth values indicated by the depth information in an alpha channel of the two-dimensional image. The encoding may include an operation of converting (e.g., quantizing) a transparency included in the alpha channel into fewer number of bits than a bit number of the alpha channel. The encoding may include an operation of obtaining a depth value represented by bits as much as a difference between a bit number of a quantized transparency and a bit number of the alpha channel. The encoding may include an operation of obtaining a concatenated value of the transparency and the depth value by coupling the quantized transparency and the obtained depth value. The encoding may include an operation of inserting (or writing) the concatenated value to the alpha channel.

Referring to FIG. 4A, in operation 430, the electronic device according to an embodiment may generate and/or store an image file (e.g., the file 110 of FIG. 1A and/or FIG. 1B) representing the visual object in which depth values and transparencies are included in the alpha channel. The electronic device may generate, together with pixel data (e.g., the pixel data 130 of FIG. 1A and/or FIG. 1B) including pixels having the alpha channel of the operation 430, metadata including information for decoding (or parsing) the depth values and the transparencies from the alpha channel of the pixels. The image file in the operation 430 may include the pixel data and the metadata.

As described above with reference to FIG. 4A, the electronic device according to an embodiment may generate an image file further including depth values corresponding to each of the pixels without increasing the number of channels (e.g., 4 channels including a red channel, a green channel, a blue channel, and an alpha channel) of the pixels. For example, the electronic device may change a purpose of the alpha channel to a channel in which both the transparency and the depth value are embedded.

FIG. 4B describes an example operation of the electronic device displaying an image and/or a video included in the image file of the operation 430. The image file of the operation 430 may be transmitted to another electronic device different from the electronic device generating the image file. The other electronic device received the image file may perform decoding and/or rendering (e.g., rendering based on two and a half dimensions) for the image file, by performing the operation of FIG. 4B. Referring to FIG. 4B, in operation 450, the electronic device according to an embodiment may identify an image file (e.g., the image file of the operation 430) representing a visual object (e.g., the visual object of the operation 410). The electronic device may perform the operation 450 in response to an input for selecting or opening the image file. The electronic device may perform the operation 450 in response to an input for browsing the image file. The input may be detected or identified based on a tap gesture (or a double-tap gesture), a mouse click (or a mouse double click), a gaze input, a hand gesture (e.g., a pinch gesture), and/or a speech (e.g., “open that file”) identified from an audio signal for an icon representing the image file.

Referring to FIG. 4B, in operation 460, the electronic device according to an embodiment may obtain depth values and transparencies corresponding to each of the pixels by decoding values encoded in the alpha channel of the pixels in the image file. A value of the alpha channel may be a concatenated value in which the transparency and the depth value are concatenated. For example, the transparency and the depth value may be sequentially stored from an MSB of the concatenated value. The electronic device may obtain or identify information required for the decoding of the operation 460 from metadata (e.g., the metadata 120 of FIG. 1A and/or FIG. 1B) of the image file. For example, the electronic device may obtain information for dividing or parsing concatenated values included in the alpha channel, from the metadata. The information may include at least one of positions and/or digits in the concatenated value of bits indicating the transparency, and positions and/or digits in the concatenated value of bits indicating the depth value.

Referring to FIG. 4B, in operation 470, the electronic device according to an embodiment may generate a three-dimensional point corresponding to at least one of pixels in the virtual space by using the obtained depth values and transparencies. For example, the electronic device may generate three-dimensional points, each corresponding to pixels having a different transparency than a preset transparency indicating a fully transparent pixel. The three-dimensional points may have three-dimensional coordinate values in the virtual space based on the depth values obtained based on the operation 460. For example, a position of the three-dimensional point in the virtual space may be determined based on a position and a depth value of a pixel corresponding to the three-dimensional point in a two-dimensional image. When a plurality of three-dimensional points are generated, the electronic device may obtain or identify a point cloud representing the visual object, including the plurality of three-dimensional points.

Referring to FIG. 4B, in operation 480, the electronic device according to an embodiment may obtain an image and/or a video three-dimensionally representing the visual object by performing rendering based on the virtual space including one or more three-dimensional points. For example, the electronic device may obtain or generate the image and/or the video, indicating a shape and/or an exterior of the three-dimensional points viewed from the virtual camera in the virtual space defined by the metadata in the image file.

Referring to FIG. 4B, in operation 490, the electronic device according to an embodiment may display the obtained image and/or video. The electronic device may display the image and/or the video on a display. The operations 480 and 490 may be referred to as a three-dimensional rendering operation for the visual object. Based on the three-dimensional rendering, the electronic device may provide a three-dimensional representation for the visual object. For example, the electronic device may display an image and/or a video having a binocular parallax. For example, the electronic device may display an image and/or a video representing the visual object that rotates three-dimensionally according to a gesture of a user.

FIG. 5 illustrates an example operation of an electronic device performing scaling for a depth value. The electronic device 101 of FIG. 1A, FIG. 1B, and/or FIG. 2 may include the electronic device of FIG. 5. The electronic device 101 and/or the processor 210 of FIG. 2 may perform an operation of the electronic device described with reference to FIG. 5.

FIG. 5 illustrates example virtual spaces 501 and 502 obtained by performing rendering for a virtual object 510. When the electronic device generates a two-dimensional image indicating the virtual object 510, the electronic device may determine depth values corresponding to each of pixels of the two-dimensional image based on a depth axis d.

For example, the electronic device generating a first virtual space 501 of FIG. 5 may determine a depth value corresponding to a point p3 of the virtual object 510 as 10. The depth value may be mapped with a pixel corresponding to the point p3 on the two-dimensional image representing the virtual object 510. Similarly, the electronic device may determine a depth value corresponding to a point p4 of the virtual object 510 as 4. The depth value may be linked with a specific pixel of a two-dimensional image corresponding to the point p4.

Referring to the example first virtual space 501 of FIG. 5, since a depth value has a range of 0 to 128, but the virtual object 510 is disposed on a portion of the first virtual space 501 having a depth value between 0 to 10, depth values corresponding to pixels representing the virtual object 510 may only be determined within a range between 0 to 10. For example, depth values between 11 to 128 may not be used. According to an embodiment, the electronic device may perform scaling on the depth value based on a range of the depth values corresponding to the pixels of the two-dimensional image.

For example, the electronic device that performs rendering for the virtual object 510 based on the first virtual space 501 may determine whether a range between a maximum value and a minimum value of the depth values corresponding to the pixels representing the virtual object 510 is smaller than an entire range of the depth value. In a case that the range is smaller than the entire range (e.g., in case of being less than a preset ratio of the entire range), the electronic device may change the depth values of the pixels by scaling the depth axis d.

FIG. 5 illustrates a second virtual space 502 obtained by scaling the depth axis d. Based on the second virtual space 502, a depth value of a pixel corresponding to a point p5 (corresponding to the point p3 of the virtual object 510 of the first virtual space 501) of a virtual object 520 may be determined as 128. Based on the second virtual space 502, a depth value of a pixel corresponding to a point p6 (corresponding to the point p4 of the virtual object 510 of the first virtual space 501) of the virtual object 520 may be determined as 10. For example, in the second virtual space 502, a depth value of pixels representing the virtual object 520 may be determined in a range of 0 to 128. That is, the electronic device may obtain more precisely determined depth values by using the second virtual space 502 in which the depth axis d is scaled. The electronic device may generate or store a file (e.g., the file 110 of FIG. 1A and/or FIG. 1B) including detailed depth values, by performing encoding based on the depth values.

In an embodiment, the image obtained based on the operation of FIG. 5 may be used as a portion of a video representing a motion of the virtual object 520. Hereinafter, an example operation of the electronic device that generates a video including image frames representing the motion of the virtual object 520 and depth information (e.g., depth information encoded in an alpha channel of pixels of the image frames) corresponding to the image frames is described with reference to FIG. 6.

FIG. 6 illustrates an example operation of an electronic device generating a video based on a key frame (e.g., a first image 631 and/or a fifth image 635). The electronic device 101 of FIG. 1A, FIG. 1B, and/or FIG. 2 may include the electronic device of FIG. 6. The electronic device 101 and/or the processor 210 of FIG. 2 may perform an operation of the electronic device described with reference to FIG. 6.

FIG. 6 illustrates an example operation of the electronic device generating a video including a plurality of images representing a motion of a virtual object. The motion may indicate a motion of a user, as described later with reference to FIG. 7. The video may be generated based on an input indicate generation and/or recording of a video.

FIG. 6 illustrates example images 631, 632, 633, 634, and 635 obtained at consecutive moments t1, t2, t3, t4, and t5 in a time area. The electronic device may generate pixel data 630 indicating a sequence of the images 631, 632, 633, 634, and 635. The pixel data 630 may include the images 631, 632, 633, 634, and 635 compressed based on a compression algorithm (e.g., a compression algorithm based on loss compression).

In an embodiment, the electronic device generating a video using the images 631, 632, 633, 634, and 635 may determine an image at a specific moment as a reference image for other images after the specific moment. The reference image may be referred to as a key frame. FIG. 6 illustrates an example state in which a first image 631 corresponding to the moment t1 is determined as the key frame. The electronic device may store a concatenated value of a transparency AAAA represented in four bits and depth values DDDD represented in four bits in an alpha channel of a first pixel having coordinates of x and y of the first image 631.

In an embodiment, in case of determining a specific image as the key frame, the electronic device may set, in the time area, depth values of pixels of one or more images, included in a preset time section after the specific image set as the key frame, as difference values for depth values of pixels of the specific image. Referring to FIG. 6, in a case that the first image 631 corresponding to the moment t1 is determined as the key frame, the electronic device may set depth values corresponding to pixels of the images 632, 633, and 634 of the moments t2, t3, and t4 included in a preset time section after the moment t1 as difference values for depth values of pixels of the first image 631.

For example, in an alpha channel of a second pixel having coordinates of x, y of a second image 632 corresponding to the moment t2, a difference value D′D′D′D′ between a depth value of the first pixel having coordinates of x, y of the first image 631 and a depth value of the second pixel may be stored. In order to obtain the depth value of the second pixel, the electronic device may obtain depth information based on a shape of a virtual object at the moment t2. The electronic device may obtain difference values between depth values indicated by the depth information and the depth values of the first image 631. Similarly, in the alpha channel of the second pixel, a difference value A′A′A′A′ between a transparency of the first pixel and a transparency of the second pixel may be stored.

Similarly, in an alpha channel of a third pixel having coordinates of x, y of a third image 633 corresponding to the moment t3, a difference value D′D′D′D′ between the depth value of the first pixel having the coordinates of x, y of the first image 631 and a depth value of the third pixel may be stored. In the alpha channel of the third pixel, a difference value A′A′A′A′ between the transparency of the first pixel and a transparency of the third pixel may be stored.

Similarly, in an alpha channel of a fourth pixel having coordinates of x, y of a fourth image 634 corresponding to the moment t4, a difference value for the transparency of the first pixel having the coordinates x, y of the first image 631 and a difference value for the depth value of the first pixel may be concatenated (A′A′A′A′A′A′D′D′D′D′). When performing three-dimensional rendering for the fourth image 634, the electronic device identifying a concatenated value of the difference values from the pixel data 630 may restore or obtain depth values and transparencies of the fourth image 634 by using the transparency and/or the depth value of the first image 631, which is the key frame.

Referring to FIG. 6, the electronic device may determine a fifth image 635 of the moment t5 after the moment t4, as the key frame. In an alpha channel of pixels of another image after the fifth image 635, the electronic device may store difference values for each of a depth value and a transparency of pixels of the fifth image 635 (A 2A 2A 2A 2D 2D 2D 2D 2).

Referring to FIG. 6, the electronic device may generate the pixel data 630 indicating a video including the images 631, 632, 633, 634, and 635. The electronic device may generate or store a file 610 including the pixel data 630 and metadata 620. The electronic device may store information indicating one or more key frames (e.g., the first image 631 and/or the fifth image 635), and information on a concatenated value stored in an alpha channel of other frames between the key frames, in the metadata 620.

As described above, in an embodiment, the electronic device selects the key frames (e.g., the first image 631 and/or the fifth image 635) based on a preset time section and calculates a value to be stored in the alpha channel of the other frames, but embodiments of the disclosure are not

For example, the electronic device may store a difference value for the depth value of the first image 631 in an alpha channel of the preset number of images positioned after the first image 631 in the time area, after determining the first image 631 at the moment t1 as the key frame. For example, in a case that the preset number is 3, the electronic device may store difference values of depth values of pixels of each of the images for the depth values of the pixels of the first image 631 in an alpha channel of three images (e.g., the second image 632, the third image 633, and the fourth image 634) after the first image 631.

In an embodiment, in a case that a video indicating a consecutive motion of a virtual object is generated, images included in the video may have relatively small differences unless a rapid motion occurs. For example, a difference value between depth values of the first image 631 and other images set as the key frame may be determined in a relatively small numerical range. Based on the numerical range, the electronic device may reduce a size (e.g., a bit number) of an alpha channel of the other images and/or depth values encoded in the alpha channel. The size reduction may reduce the pixel data 630 indicating the video and/or a size of the file 610.

In an embodiment, in a case that the video indicating the consecutive motion of the virtual object is generated, the images included in the video may have a relatively large difference in a case that a rapit motion occurs. In this case, differences of depth values of the images may be changed in a relatively large numerical range. According to an embodiment, in a case that a difference between depth values of the first image 631, which is the key frame, and another image exceeds a reference range, the electronic device may store a depth value of the other image without storing a difference value between the depth value of the first image 631 and the depth value of the other image in an alpha channel of the other image. For example, in a case that the difference between the depth values of the first image 631, which is the key frame, and another image exceeds the reference range, concatenated values of depth values and transparencies of the other image may be included in an alpha channel of pixels of the other image.

FIG. 7 illustrates an example operation of an electronic device 101 generating a video indicating a motion of a visual object 720 by using sensor data. The electronic device 101 of FIG. 1A, FIG. 1B, and/or FIG. 2 may include the electronic device 101 of FIG. 7. The electronic device 101 and/or the processor 210 of FIG. 2 may perform an operation of the electronic device 101 described with reference to FIG. 7. The operation described with reference to FIG. 7 may be associated with at least one of the operations of FIG. 4A.

FIG. 7 illustrates the electronic device 101 with a shape of an HM D including a plurality of displays 711 and 712. Each of the plurality of displays 711 and 712 may be configured to be disposed toward two eyes of a user 105 when worn by the user 105. For example, a first display 711 may be disposed toward a left eye of the user 105, and a second display 712 may be disposed toward a right eye of the user 105. A combination of the plurality of displays 711 and 712 may be referred to as a display assembly and/or a display module.

Referring to FIG. 7, in a case that the visual object 720 is set to simulate a motion of the user 105, the electronic device 101 may obtain sensor data indicating the motion of the user 105 by using a sensor (e.g., the sensor 240 of FIG. 2) configured to detect the motion of the user 105. For example, the electronic device 101 may obtain sensor data indicating a direction d_hmd of the electronic device 101 by using the sensor. In a case that the user 105 wears the electronic device 101, the direction d_hmd of the electronic device 101 indicated by the sensor data may be linked to a direction of a head of the user 105. In a case that the visual object 720 is set to simulate the motion of the user 105, a direction d_avt of the visual object 720 viewed through the displays 711 and 712 may be synchronously changed with the direction d_hmd of the electronic device 101.

FIG. 7 illustrates an example state of the electronic device 101 generating a video indicating a motion of the visual object 720, referred to as an avatar and/or a virtual object. The electronic device 101 may start generating the video based on a preset input. In a case that the visual object 720 is set to simulate the motion of the user 105, the video generated by the electronic device 101 may indicate the visual object 720 that simulates the motion of the user 105 detected while generating the video.

Referring to FIG. 7, while generating (or recording) a video, the electronic device 101 may display a visual object 730 for receiving an input to cease generation of the video on the displays 711 and 712. FIG. 7 illustrates the visual object 730 including preset text such as “stop”. However, a shape or a position of the visual object 730 of the present disclosure is not limited to the above visual object 730 of FIG. 7. While generating the video, the electronic device 101 may detect the motion of the user 105 by using the sensor data detected from the sensor. While generating the video, the electronic device 101 may at least partially change the visual object 720 displayed on the displays 711 and 712 to simulate the detected motion. While generating the video, the electronic device 101 may obtain a plurality of images representing the at least partially changed visual object 720. The plurality of images may be included in one file (e.g., the file 610 of FIG. 6) based on the operation described with reference to FIG. 6.

As described above with reference to FIG. 6, the electronic device 101 according to an embodiment may select a specific image as a key frame among images indicating the motion of the visual object 720. A depth value, a transparency, and/or a color of pixels of another image may be represented as a difference value for a depth value, a transparency, and/or a color of pixels of the specific image selected as the key frame. The electronic device 101 may select the key frame according to intensity (and/or a size) of the motion of the user 105 indicated by the sensor data.

For example, in a case that a first image at a first moment is selected as the key frame, the electronic device 101 may detect the sensor data indicating the motion of the user 105 from the sensor at a second moment after the first moment. The electronic device 101 may identify a difference between the sensor data detected at the first moment and the sensor data detected at the second moment. In a case that the difference is included in a reference range, the electronic device may store difference values between depth values of the first image and a second image in an alpha channel of pixels of the second image. For example, the electronic device may generate the second image corresponding to the second moment, in which difference values of depth values included in an alpha channel of the first image and other depth values obtained based on sensor data at the second moment and indicated by other depth information are respectively included in an alpha channel of pixels.

For example, in a case that a difference between the sensor data at the first moment and the sensor data at the second moment is outside the reference range (e.g., in a case that the difference exceeds the reference range), the electronic device may store concatenated values of the depth values of the second image and transparencies of the second image in the alpha channel of the pixels of the second image. For example, the electronic device may generate the second image corresponding to the second moment, in which the other depth values are included in the alpha channel of the pixels, respectively. The electronic device may generate a file including the first image and the second image.

As described above, while generating the video for the visual object 720 simulating the motion of the user 105, the electronic device 101 may select or determine the key frame based on the intensity and/or the size of the motion. For example, at a moment of detecting a relatively rapid motion, the electronic device 101 may determine an image obtained at the moment as the key frame. While detecting a relatively small motion, the electronic device 101 may select or determine the key frame based on a reference (e.g., a preset period, and/or the preset number) described with reference to FIG. 6.

FIG. 8 illustrates an example operation of an electronic device 101 performing three-dimensional rendering on a visual object 810 represented by an image file. The electronic device 101 of FIG. 1A, FIG. 1B, and/or FIG. 2 may include the electronic device 101 of FIG. 8. The electronic device 101 and/or the processor 210 of FIG. 2 may perform an operation of the electronic device 101 described with reference to FIG. 8. The operation described with reference to FIG. 8 may be associated with at least one of the operations of FIG. 4B.

FIG. 8 illustrates an example state of the electronic device 101 that performs rendering for the visual object 810 referred to as an avatar and/or a virtual object. The electronic device 101 may receive an input for displaying an image and/or a video indicated by a file (e.g., the file 110 of FIG. 1A and/or FIG. 1B and/or the file 610 of FIG. 6). The electronic device 101 receiving the input may obtain colors, transparencies, and depth values of pixels of the image and/or the video from pixel data of the file. For example, the electronic device 101 may identify or obtain depth values included in an alpha channel of the pixels. The electronic device 101 may determine a binocular parallax of each of the pixels based on the obtained depth values. The electronic device 101 may display an image representing the visual object 810 on a first display 711 based on the determined binocular parallax. The electronic device 101 may display another image representing the visual object 810 shifted based on the binocular parallax on a second display 712.

For example, according to depth values identified from a concatenated value of an alpha channel, portions of the visual object 810 displayed on the first display 711 may be shifted from portions of the visual object 810 displayed on the second display 712, respectively. Referring to FIG. 8, when displaying the visual object 810 having a shape of an avatar wearing a hat, a binocular parallax of a portion (e.g., a portion 811 corresponding to the hat) of the visual object 810 set to be positioned relatively close from a user 105 may be greater than another portion (e.g., a portion 812 corresponding to a hair) of the visual object 810. From an alpha channel of pixels of an image included in the file, the electronic device 101 may identify depth values and transparencies of portions of the visual object 810 corresponding to each of the pixels. The electronic device 101 may control a display assembly including the displays 711 and 712 to display the visual object 810 represented based on the transparencies. Referring to FIG. 8, a background area 820 beyond the visual object 810 may be displayed in a portion (e.g., a portion outside a boundary of a face represented by the visual object 810) of a display area adjacent to the visual object 810, by the pixels having the transparencies.

In an embodiment, when playing a video representing a motion of the visual object 810, the electronic device 101 may display a visual object 830 for at least temporarily ceasing playback of the video on the displays 711 and 712. The video may be included in the file (e.g., the file 610 of FIG. 6) generated based on the operation described with reference to FIG. 6 and/or FIG. 7.

As described above, the electronic device 101 according to an embodiment may provide information for three-dimensional rendering (e.g., point cloud rendering) of the visual object 810 together with a two-dimensional image for the visual object 810, such as an avatar, by inserting a depth value as well as a transparency to the alpha channel. The file (e.g., the file 110 of FIG. 1A and/or FIG. 1B and/or the file 610 of FIG. 6) generated by the electronic device 101 may include pixels based on a red channel, a green channel, a blue channel, and an alpha channel, and since no additional channel for storing a depth value is defined, may be compatible with a graphics pipeline (e.g., hardware, software, or a combination thereof for representing a color and a transparency, excluding a depth value, using four channels) capable of reading only the four channels described above. For example, an external electronic device executing an existing graphics pipeline may generate or display a two-dimensional image and/or a two-dimensional video for the visual object 810 by performing a two-dimensional rendering for the visual object 810.

FIG. 9A illustrates an example of a perspective view of an electronic device according to an embodiment. FIG. 9B illustrates an example of one or more hardware components disposed in the electronic device 101. According to an embodiment, an electronic device 101 may have a shape of glasses wearable on a body part (e.g., the head) of a user (e.g., the user 105 of FIG. 1A and/or FIG. 1B). The electronic device 101 of FIGS. 9A and 9B may be an example of the electronic device 101 of FIGS. 1A and/or 1B. The electronic device 101 may include a HM D. For example, a housing of the electronic device 101 may include flexible materials, such as rubber and/or silicone, that have a shape in close contact with a portion (e.g., a portion of the face surrounding both eyes) of the user's head. For example, the housing of the electronic device 101 may include one or more straps able to be twined around the user's head, and/or one or more temples attachable to an ear of the head.

Referring to FIG. 9A, according to an embodiment, the electronic device 101 may include at least one display 950 and a frame 900 900 supporting the at least one display 950.

According to an embodiment, the electronic device 101 may be wearable on a portion of the user's body. The electronic device 101 may provide AR, VR, or MR (combining the AR and the VR) to a user wearing the electronic device 101. For example, the electronic device 101 may display a virtual reality image provided from at least one optical device 982 and 984 of FIG. 9B on at least one display 950, in response to a user's preset gesture obtained through a motion recognition camera 960-2 and 960-3 of FIG. 9B.

According to an embodiment, the at least one display 950 may provide visual information to a user. For example, the at least one display 950 may include a transparent or translucent lens. The at least one display 950 may include a first display 950-1 and/or a second display 950-2 spaced apart from the first display 950-1. For example, the first display 950-1 and the second display 950-2 may be disposed at positions corresponding to the user's left and right eyes, respectively.

Referring to FIG. 9B, the at least one display 950 may provide visual information transmitted through a lens included in the at least one display 950 from ambient light to a user and other visual information distinguished from the visual information 9. The lens may be formed based on at least one of a Fresnel lens, a pancake lens, or a multi-channel lens. For example, the at least one display 950 may include a first surface 931 and a second surface 932 opposite to the first surface 931. A display area may be formed on the second surface 932 of at least one display 950. When the user wears the electronic device 101, ambient light may be transmitted to the user by being incident on the first surface 931 and being penetrated through the second surface 932. For another example, the at least one display 950 may display an AR image in which a virtual reality image provided by the at least one optical device 982 and 984 is combined with a reality screen transmitted through ambient light, on a display area formed on the second surface 932.

According to an embodiment, the at least one display 950 may include at least one waveguide 933 and 934 that transmits light transmitted from the at least one optical device 982 and 984 by diffracting to the user. The at least one waveguide 933 and 934 may be formed based on at least one of glass, plastic, or polymer. A nano pattern may be formed on at least a portion of the outside or inside of the at least one waveguide 933 and 934. The nano pattern may be formed based on a grating structure having a polygonal or curved shape. Light incident to an end of the at least one waveguide 933 and 934 may be propagated to another end of the at least one waveguide 933 and 934 by the nano pattern. The at least one waveguide 933 and 934 may include at least one of at least one diffraction element (e.g., a diffractive optical element (DOE), a holographic optical element (HOE)), and a reflection element (e.g., a reflection mirror). For example, the at least one waveguide 933 and 934 may be disposed in the electronic device 101 to guide a screen displayed by the at least one display 950 to the user's eyes. For example, the screen may be transmitted to the user's eyes based on total internal reflection (TIR) generated in the at least one waveguide 933 and 934.

The electronic device 101 may analyze an object included in a real image collected through a photographing camera 960-4, combine with a virtual object corresponding to an object that become a subject of AR provision among the analyzed object, and display on the at least one display 950. The virtual object may include at least one of text and images for various information associated with the object included in the real image. The electronic device 101 may analyze the object based on a multi-camera such as a stereo camera. For the object analysis, the electronic device 101 may execute space recognition (e.g., simultaneous localization and mapping (SLA M)) using the multi-camera and/or time-of-flight (ToF). The user wearing the electronic device 101 may watch an image displayed on the at least one display 950.

According to an embodiment, a frame 900 may be configured with a physical structure in which the electronic device 101 may be worn on the user's body. According to an embodiment, the frame 900 may be configured so that when the user wears the electronic device 101, the first display 950-1 and the second display 950-2 may be positioned corresponding to the user's left and right eyes. The frame 900 may support the at least one display 950. For example, the frame 900 may support the first display 950-1 and the second display 950-2 to be positioned at positions corresponding to the user's left and right eyes.

Referring to FIG. 9A, according to an embodiment, the frame 900 may include an area 920 at least partially in contact with the portion of the user's body in a case that the user wears the electronic device 101. For example, the area 920 of the frame 900 in contact with the portion of the user's body may include an area in contact with a portion of the user's nose, a portion of the user's ear, and a portion of the side of the user's face that the electronic device 101 contacts. According to an embodiment, the frame 900 may include a nose pad 910 that is contacted on the portion of the user's body. When the electronic device 101 is worn by the user, the nose pad 910 may be contacted on the portion of the user's nose. The frame 900 may include a first temple 904 and a second temple 905, which are contacted on another portion of the user's body that is distinct from the portion of the user's body.

For example, the frame 900 may include a first rim 901 surrounding at least a portion of the first display 950-1, a second rim 902 surrounding at least a portion of the second display 950-2, a bridge 903 disposed between the first rim 901 and the second rim 902, a first pad 911 disposed along a portion of the edge of the first rim 901 from one end of the bridge 903, a second pad 912 disposed along a portion of the edge of the second rim 902 from the other end of the bridge 903, the first temple 904 extending from the first rim 901 and fixed to a portion of the wearer's ear, and the second temple 905 extending from the second rim 902 and fixed to a portion of the ear opposite to the ear. The first pad 911 and the second pad 912 may be in contact with the portion of the user's nose, and the first temple 904 and the second temple 905 may be in contact with a portion of the user's face and the portion of the user's ear. The temples 904 and 905 may be rotatably connected to the rim through hinge units 906 and 907 of FIG. 9B. The first temple 904 may be rotatably connected with respect to the first rim 901 through the first hinge unit 906 disposed between the first rim 901 and the first temple 904. The second temple 905 may be rotatably connected with respect to the second rim 902 through the second hinge unit 907 disposed between the second rim 902 and the second temple 905. According to an embodiment, the electronic device 101 may identify an external object (e.g., a user's fingertip) touching the frame 900 and/or a gesture performed by the external object by using a touch sensor, a grip sensor, and/or a proximity sensor formed on at least a portion of the surface of the frame 900.

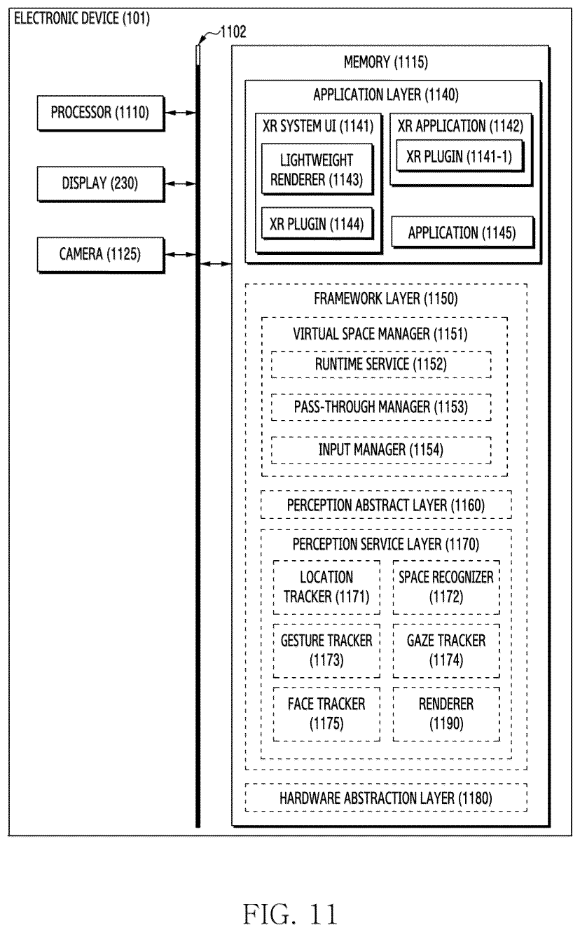

According to an embodiment, the electronic device 101 may include hardware (e.g., hardware to be described below based on the block diagram of FIG. 11) that performs various functions. For example, the hardware may include a battery module 970, an antenna module 975, the at least one optical device 982 and 984, speakers (e.g., speakers 955-1 and 955-2), a microphone (e.g., microphones 965-1, 965-2, and 965-3), a light emitting module, and/or a printed circuit board (PCB) 990 (e.g., printed circuit board). Various hardware may be disposed in the frame 900.

According to an embodiment, the microphone (e.g., the microphones 965-1, 965-2, and 965-3) of the electronic device 101 may obtain a sound signal, by being disposed on at least a portion of the frame 900. The first microphone 965-1 disposed on the bridge 903, the second microphone 965-2 disposed on the second rim 902, and the third microphone 965-3 disposed on the first rim 901 are illustrated in FIG. 9B, but the number and disposition of the microphone 965 are not limited to the embodiment of FIG. 9B. In a case that the number of the microphone 965 included in the electronic device 101 is two or more, the electronic device 101 may identify a direction of the sound signal by using a plurality of microphones disposed on different portions of the frame 900.

According to an embodiment, the at least one optical device 982 and 984 may project a virtual object on the at least one display 950 in order to provide various image information to the user. For example, the at least one optical device 982 and 984 may be a projector. The at least one optical device 982 and 984 may be disposed adjacent to the at least one display 950 or may be included in the at least one display 950 as a portion of the at least one display 950. According to an embodiment, the electronic device 101 may include a first optical device 982 corresponding to the first display 950-1, and a second optical device 984 corresponding to the second display 950-2. For example, the at least one optical device 982 and 984 may include the first optical device 982 disposed at a periphery of the first display 950-1 and the second optical device 984 disposed at a periphery of the second display 950-2. The first optical device 982 may transmit light to the first waveguide 933 disposed on the first display 950-1, and the second optical device 984 may transmit light to the second waveguide 934 disposed on the second display 950-2.

In an embodiment, a camera 960 may include the photographing camera 960-4, an eye tracking camera (ET CAM) 960-1, and/or the motion recognition camera 960-2 and 960-3. The photographing camera 960-4, the eye tracking camera 960-1, and the motion recognition camera 960-2 and 960-3 may be disposed at different positions on the frame 900 and may perform different functions. The eye tracking camera 960-1 may output data indicating a position of eye or a gaze of the user wearing the electronic device 101. For example, the electronic device 101 may detect the gaze from an image including the user's pupil obtained through the eye tracking camera 960-1. The electronic device 101 may identify an object (e.g., a real object, and/or a virtual object) focused by the user, by using the user's gaze obtained through the eye tracking camera 960-1. The electronic device 101 identifying the focused object may execute a function (e.g., gaze interaction) for interaction between the user and the focused object. The electronic device 101 may represent a portion corresponding to eye of an avatar indicating the user in the virtual space, by using the user's gaze obtained through the eye tracking camera 960-1. The electronic device 101 may render an image (or a screen) displayed on the at least one display 950, based on the position of the user's eye. For example, visual quality (e.g., resolution, brightness, saturation, grayscale, and PPI) of a first area related to the gaze within the image and visual quality of a second area distinguished from the first area may be different. The electronic device 101 may obtain an image having the visual quality of the first area matching the user's gaze and the visual quality of the second area by using foveated rendering. For example, when the electronic device 101 supports an iris recognition function, user authentication may be performed based on iris information obtained using the eye tracking camera 960-1. An example in which the eye tracking camera 960-1 is disposed toward the user's right eye is illustrated in FIG. 9B, but the embodiment is not limited thereto, and the eye tracking camera 960-1 may be disposed alone toward the user's left eye or may be disposed toward two eyes.

In an embodiment, the photographing camera 960-4 may photograph a real image or background to be matched with a virtual image in order to implement the AR or MR content. The photographing camera 960-4 may be used to obtain an image having a high resolution based on a high resolution (HR) or a photo video (PV). The photographing camera 960-4 may photograph an image of a specific object existing at a position viewed by the user and may provide the image to the at least one display 950. The at least one display 950 may display one image in which a virtual image provided through the at least one optical device 982 and 984 is overlapped with information on the real image or background including an image of the specific object obtained by using the photographing camera 960-4. The electronic device 101 may compensate for depth information (e.g., a distance between the electronic device 101 and an external object obtained through a depth sensor), by using an image obtained through the photographing camera 960-4. The electronic device 101 may perform object recognition through an image obtained using the photographing camera 960-4. The electronic device 101 may perform a function (e.g., auto focus) of focusing an object (or subject) within an image and/or an optical image stabilization (OIS) function (e.g., an anti-shaking function) by using the photographing camera 960-4. While displaying a screen representing a virtual space on the at least one display 950, the electronic device 101 may perform a pass through function for displaying an image obtained through the photographing camera 960-4 overlapping at least a portion of the screen. In an embodiment, the photographing camera 960-4 may be disposed on the bridge 903 disposed between the first rim 901 and the second rim 902.

The eye tracking camera 960-1 may implement a more realistic AR by matching the user's gaze with the visual information provided on the at least one display 950, by tracking the gaze of the user wearing the electronic device 101. For example, when the user looks at the front, the electronic device 101 may naturally display environment information associated with the user's front on the at least one display 950 at a position where the user is positioned. The eye tracking camera 960-1 may be configured to capture an image of the user's pupil in order to determine the user's gaze. For example, the eye tracking camera 960-1 may receive gaze detection light reflected from the user's pupil and may track the user's gaze based on the position and movement of the received gaze detection light. In an embodiment, the eye tracking camera 960-1 may be disposed at a position corresponding to the user's left and right eyes. For example, the eye tracking camera 960-1 may be disposed in the first rim 901 and/or the second rim 902 to face the direction in which the user wearing the electronic device 101 is positioned.

The motion recognition camera 960-2 and 960-3 may provide a specific event to the screen provided on the at least one display 950 by recognizing the movement of the whole or portion of the user's body, such as the user's torso, hand, or face. The motion recognition camera 960-2 and 960-3 may obtain a signal corresponding to motion by recognizing the user's motion (e.g., gesture recognition), and may provide a display corresponding to the signal to the at least one display 950. The processor may identify a signal corresponding to the operation and may perform a preset function based on the identification. The motion recognition camera 960-2 and 960-3 may be used to perform simultaneous localization and mapping (SLAM) for 6 degrees of freedom pose (6 dof pose) and/or a space recognition function using a depth map. The processor may perform a gesture recognition function and/or an object tracking function, by using the motion recognition camera 960-2 and 960-3. In an embodiment, the motion recognition camera 960-2 and camera 960-3 may be disposed on the first rim 901 and/or the second rim 902.

The camera 960 included in the electronic device 101 is not limited to the above-described eye tracking camera 960-1 and the motion recognition camera 960-2 and 960-3. For example, the electronic device 101 may identify an external object included in the FoV by using a camera disposed toward the user's FoV. The electronic device 101 identifying the external object may be performed based on a sensor for identifying a distance between the electronic device 101 and the external object, such as a depth sensor and/or a time of flight (ToF) sensor. The camera 960 disposed toward the FoV may support an autofocus function and/or an optical image stabilization (OIS) function. For example, in order to obtain an image including a face of the user wearing the electronic device 101, the electronic device 101 may include the camera 960 (e.g., a face tracking (FT) camera) disposed toward the face.

In an embodiment, the electronic device 101 may further include a light source (e.g., LED) that emits light toward a subject (e.g., user's eyes, face, and/or an external object in the FoV) photographed by using the camera 960. The light source may include an LED having an infrared wavelength. The light source may be disposed on at least one of the frame 900, and the hinge units 906 and 907.

According to an embodiment, the battery module 970 may supply power to electronic components of the electronic device 101. In an embodiment, the battery module 970 may be disposed in the first temple 904 and/or the second temple 905. For example, the battery module 970 may be a plurality of battery modules 970. The plurality of battery modules 970, respectively, may be disposed on each of the first temple 904 and the second temple 905. In an embodiment, the battery module 970 may be disposed at an end of the first temple 904 and/or the second temple 905.

The antenna module 975 may transmit the signal or power to the outside of the electronic device 101 or may receive the signal or power from the outside. In an embodiment, the antenna module 975 may be disposed in the first temple 904 and/or the second temple 905. For example, the antenna module 975 may be disposed close to one surface of the first temple 904 and/or the second temple 905.

A speaker 955 may output a sound signal to the outside of the electronic device 101. A sound output module may be referred to as a speaker. In an embodiment, the speaker 955 may be disposed in the first temple 904 and/or the second temple 905 in order to be disposed adjacent to the ear of the user wearing the electronic device 101. For example, the speaker 955 may include a second speaker 955-2 disposed adjacent to the user's left ear by being disposed in the first temple 904, and a first speaker 955-1 disposed adjacent to the user's right ear by being disposed in the second temple 905.

The light emitting module may include at least one light emitting element. The light emitting module may emit light of a color corresponding to a specific state or may emit light through an operation corresponding to the specific state in order to visually provide information on a specific state of the electronic device 101 to the user. For example, when the electronic device 101 requires charging, it may emit red light at a constant cycle. In an embodiment, the light emitting module may be disposed on the first rim 901 and/or the second rim 902.

Referring to FIG. 9B, according to an embodiment, the electronic device 101 may include the printed circuit board (PCB) 990. The PCB 990 may be included in at least one of the first temple 904 or the second temple 905. The PCB 990 may include an interposer disposed between at least two sub PCBs. On the PCB 990, one or more hardware (e.g., hardware illustrated by blocks of FIG. 11) included in the electronic device 101 may be disposed. The electronic device 101 may include a flexible PCB (FPCB) for interconnecting the hardware.

According to an embodiment, the electronic device 101 may include at least one of a gyro sensor, a gravity sensor, and/or an acceleration sensor for detecting the posture of the electronic device 101 and/or the posture of a body part (e.g., a head) of the user wearing the electronic device 101. Each of the gravity sensor and the acceleration sensor may measure gravity acceleration, and/or acceleration based on preset 3-dimensional axes (e.g., x-axis, y-axis, and z-axis) perpendicular to each other. The gyro sensor may measure angular velocity of each of preset 3-dimensional axes (e.g., x-axis, y-axis, and z-axis). At least one of the gravity sensor, the acceleration sensor, and the gyro sensor may be referred to as an inertial measurement unit (IM U). According to an embodiment, the electronic device 101 may identify the user's motion and/or gesture performed to execute or stop a specific function of the electronic device 101 based on the IMU.

FIGS. 10A and 10B illustrate an example of an exterior of an electronic device (e.g., the electronic device 101). The electronic device 101 of FIGS. 10A and 10B may be an example of the electronic device 101 of FIGS. 1A and/or 1B. According to an embodiment, an example of an exterior of a first surface 1010 of a housing of the electronic device 101 may be illustrated in FIG. 10A, and an example of an exterior of a second surface 1020 opposite to the first surface 1010 may be illustrated in FIG. 10B.

Referring to FIG. 10A, according to an embodiment, the first surface 1010 of the electronic device 101 may have an attachable shape on the user's body part (e.g., the user's face). In an embodiment, the electronic device 101 may further include a strap for being fixed on the user's body part, and/or one or more temples (e.g., the first temple 904 and/or the second temple 905 of FIGS. 9A to 9B). A first display 950-1 for outputting an image to the left eye among the user's two eyes and a second display 950-2 for outputting an image to the right eye among the user's two eyes may be disposed on the first surface 1010. The electronic device 101 may further include rubber or silicon packing, which are formed on the first surface 1010, for preventing interference by light (e.g., ambient light) different from the light emitted from the first display 950-1 and the second display 950-2.

According to an embodiment, the electronic device 101 may include camera 960-1 for photographing and/or tracking two eyes of the user adjacent to each of the first display 950-1 and the second display 950-2. The cameras 960-1 may be referred to as the gaze tracking camera 960-1 of FIG. 9B. According to an embodiment, the electronic device 101 may include cameras 960-5 and 960-6 for photographing and/or recognizing the user's face. The cameras 960-5 and 960-6 may be referred to as a FT camera. The electronic device 101 may control an avatar representing a user in a virtual space, based on a motion of the user's face identified using the cameras 960-5 and 960-6. For example, the electronic device 101 may change a texture and/or a shape of a portion (e.g., a portion of an avatar representing a human face) of the avatar, by using information obtained by the cameras 960-5 and 960-6 (e.g., the FT camera) and representing the facial expression of the user wearing the electronic device 101.

Referring to FIG. 10B, a camera (e.g., cameras 960-7, 960-8, 960-9, 960-10, 960-11, and 960-12), and/or a sensor (e.g., the depth sensor 1030) for obtaining information associated with the external environment of the electronic device 101 may be disposed on the second surface 1020 opposite to the first surface 1010 of FIG. 10A. For example, the cameras 960-7, 960-8, 960-9, and 960-10 may be disposed on the second surface 1020 in order to recognize an external object. The cameras 960-7, 960-8, 960-9, and 960-10 may be referred to as the motion recognition cameras 960-2 and 960-3 of FIG. 9B.

For example, by using cameras 960-11 and 960-12, the electronic device 101 may obtain an image and/or video to be transmitted to each of the user's two eyes. The camera 960-11 may be disposed on the second surface 1020 of the electronic device 101 to obtain an image to be displayed through the second display 950-2 corresponding to the right eye among the two eyes. The camera 960-12 may be disposed on the second surface 1020 of the electronic device 101 to obtain an image to be displayed through the first display 950-1 corresponding to the left eye among the two eyes. The cameras 960-11 and 960-12 may be referred to as the photographing camera 960-4 of FIG. 9B.

According to an embodiment, the electronic device 101 may include the depth sensor 1030 disposed on the second surface 1020 in order to identify a distance between the electronic device 101 and the external object. By using the depth sensor 1030, the electronic device 101 may obtain spatial information (e.g., a depth map) about at least a portion of the FoV of the user wearing the electronic device 101. In an embodiment, a microphone for obtaining sound outputted from the external object may be disposed on the second surface 1020 of the electronic device 101. The number of microphones may be one or more according to embodiments.

Hereinafter, a hardware or software configuration of the electronic device 101 will be described with reference to FIG. 11.

FIG. 11 illustrates an example of a block diagram of an electronic device (e.g., electronic device 101). The electronic device 101 of FIG. 11 may be an example of the electronic device 101 of FIGS. 1A and/or 1B, and the electronic device 101 of FIGS. 9A to 10B.

Referring to FIG. 11, the electronic device 101 according to an embodiment may include a processor 1110, memory 1115, a display 230 (e.g., the display 230 of FIG. 2, FIG. 9A, FIG. 9B, FIG. 10A, and the first display 950-1 and/or the second display 950-2 of FIG. 10B) and/or a sensor 1120. The processor 1110, the memory 1115, the display 230, and/or the sensor 1120 may be electrically and/or operably connected to each other by an electronic component such as a communication bus 1102. The processor 1110, the display 230, and the memory 1115 of FIG. 11 may correspond to each of the processor 210, the display 230, and the memory 220 of FIG. 2. Among the descriptions of the processor 1110, the display 230, and the memory 1115 of FIG. 11, descriptions overlapping those of the processor 210, the display 230, and the memory 220 of FIG. 2 may be omitted. The camera 1125 of FIG. 11 may correspond to the sensor 240 and/or the image sensor of FIG. 2.

According to an embodiment, one or more instructions (or commands) indicating data to be processed by the processor 1110 of the electronic device 101, calculations and/or operations to be performed may be stored in the memory 1115 of the electronic device 101. A set of one or more instructions may be referred to as a program, firmware, operating system, process, routine, sub-routine, and/or software application (hereinafter referred to as application). For example, the electronic device 101 and/or the processor 1110 may perform at least one of operations of FIGS. 4A and 4B, when a set of a plurality of instruction distributed in the form of an operating system, firmware, driver, program, and/or software application is executed. Hereinafter, a software application being installed within the electronic device 101 may mean that one or more instructions provided in the form of a software application (or package) are stored in the memory 1115, and that the one or more applications are stored in an executable format (e.g., a file with an extension designated by the operating system of the electronic device 101) by the processor 1110. As an example, the application may include a program and/or a library, associated with a service provided to a user.

Referring to FIG. 11, programs installed in the electronic device 101 may be included in any one among different layers including an application layer 1140, a framework layer 1150, and/or a hardware abstraction layer (HAL) 1180, based on a target. For example, programs (e.g., module or driver) designed to target a hardware (e.g., the display 230, and/or the sensor 1120) of the electronic device 101 may be included in the hardware abstraction layer 1180. In terms of including one or more programs for providing an XR service, the framework layer 1150 may be referred to as an XR framework layer. For example, the layers illustrated in FIG. 11, which are logically separated, may not mean that an address space of the memory 1115 is divided by the layers.

For example, programs (e.g., location tracker 1171, space recognizer 1172, gesture tracker 1173, gaze tracker 1174, and/or face tracker 1175) designed to target at least one of the hardware abstraction layer 1180 and/or the application layer 1140 may be included within framework layer 1150. Programs included in the framework layer 1150 may provide an application programming interface (API) capable of being executed (or called) based on other programs.

For example, a program designed to target a user of the electronic device 101 may be included in the application layer 1140. An XR system user interface (UI) 1141 or an XR application 1142 is illustrated as an example of programs included in the application layer 1140, but embodiments of the present disclosure are not limited thereto. For example, programs (e.g., software application) included in the application layer 1140 may cause execution of a function supported by programs included in the framework layer 1150, by calling the API.

For example, the electronic device 101 may display, on the display 230, one or more visual objects for performing interaction with the user, based on the execution of the XR system UI 1141. The visual object may mean an object capable of being positioned within a screen for transmission of information and/or interaction, such as text, image, icon, video, button, check box, radio button, text box, slider and/or table. The visual object may be referred to as a visual guide, a virtual object, a visual element, a UI element, a view object, and/or a view element. The electronic device 101 may provide functions available in a virtual space to the user, based on the execution of the X R system UI 1141.

FIG. 11 describes the XR system UI 1141 that includes a lightweight renderer 1143 and/or an X R plug-in 1144, but embodiments of the present disclosure are not limited thereto. For example, the processor 1110 may execute the lightweight renderer 1143 and/or the X R plug-in 1144 in the framework layer 1150, based on the XR system UI 1141.

For example, the electronic device 101 may obtain a resource (e.g., A PI, system process, and/or library) used to define, create, and/or execute a rendering pipeline in which partial changes are allowed, based on the execution of the lightweight renderer 1143. The lightweight renderer 1143 may be referred to as a lightweight renderer pipeline in terms of defining a rendering pipeline in which partial changes are allowed. The lightweight renderer 1143 may include a renderer (e.g., a prebuilt renderer) built before execution of a software application. For example, the electronic device 101 may obtain a resource (e.g., A PI, system process, and/or library) used to define, create, and/or execute the entire rendering pipeline, based on the execution of the X R plug-in 1144. The XR plug-in 1144 may be referred to as an open XR native client in terms of defining (or setting) the entire rendering pipeline.

For example, the electronic device 101 may display a screen representing at least a portion of a virtual space on the display 230, based on the execution of the X R application 1142. The XR plug-in 1144-1 included in the X R application 1142 may include instructions supporting a function similar to the XR plug-in 1144 of the XR system UI 1141. Among descriptions of the XR plug-in 1144-1, a description overlapping those of the X R plug-in 1144 may be omitted. The electronic device 101 may cause execution of a virtual space manager 1151, based on execution of the X R application 1142.

For example, the electronic device 101 may display an image in a virtual space on the display 230, based on execution of an application 1145. The application 1145 may be configured to output image information for displaying a two-dimensional image. The electronic device 101 may cause execution of the virtual space manager 1151, based on execution of the application 1145. The electronic device 101 may create double image information to represent the two-dimensional image in a three-dimensional virtual space, based on the execution of the application 1145. Herein, the double image information may include first image information for the left eye and second image information for the right eye, in consideration of binocular disparity. In order to represent the two-dimensional image in the three-dimensional virtual space, the electronic device 101 may create the double image information, based on image information for displaying the two-dimensional image.

According to an embodiment, the electronic device 101 may provide a virtual space service, based on the execution of the virtual space manager 1151. For example, the virtual space manager 1151 may include a platform for supporting a virtual space service. Based on the execution of the virtual space manager 1151, the electronic device 101 may identify a virtual space formed based on a user's location indicated by data obtained through the sensor 1130, and may display at least a portion of the virtual space on the display 230. The virtual space manager 1151 may be referred to as a composition presentation manager (CPM).

For example, the virtual space manager 1151 may include a runtime service 1152. As an example, the runtime service 1152 may be referred to as an OpenXR runtime module (or OpenXR runtime program). The electronic device 101 may execute at least one of a user's pose prediction function, a frame timing function, and/or a space input function, based on the execution of the runtime service 1152. As an example, the electronic device 101 may perform rendering for a virtual space service to a user, based on the execution of the runtime service 1152. For example, based on the execution of runtime service 1152, a function associated with a virtual space executable by the application layer 1140 may be supported.

For example, the virtual space manager 1151 may include a pass-through manager 1153. The electronic device 101 may display an image and/or a video representing an actual space obtained through an external camera superimposed on at least a portion of the screen, while displaying a screen (e.g., the screen of FIG. 1A) representing a virtual space on display 230, based on the execution of the pass-through manager 1153.

For example, the virtual space manager 1151 may include an input manager 1154. The electronic device 101 may identify data (e.g., sensor data) obtained by executing one or more programs included in a perception service layer 1170, based on the execution of the input manager 1154. The electronic device 101 may identify a user input associated with the electronic device 101, by using the obtained data. The user input may be associated with the user's motion (e.g., hand gesture), gaze, and/or speech identified by the sensor 1120 (e.g., an image sensor such as an external camera). The user input may be identified based on an external electronic device connected (or paired) through a communication circuit.

For example, a perception abstract layer 1160 may be used for data exchange between the virtual space manager 1151 and the perception service layer 1170. In terms of being used for data exchange between the virtual space manager 1151 and the perception service layer 1170, the perception abstract layer 1160 may be referred to as an interface. As an example, the perception abstraction layer 1160 may be referred to as OpenPX. The perception abstraction layer 1160 may be used for a perception client and a perception service.

According to an embodiment, the perception service layer 1170 may include one or more programs for processing data obtained from the sensor 1120. One or more programs may include at least one of the location tracker 1171, the space recognizer 1172, the gesture tracker 1173, and/or the gaze tracker 1174. The type and/or number of one or more programs included in the perception service layer 1170 is not limited as illustrated in FIG. 11.

For example, the electronic device 101 may identify a posture of the electronic device 101 by using the sensor 1130, based on the execution of the location tracker 1171. The electronic device 101 may identify 6 degrees of freedom pose (6 dof pose) of the electronic device 101, based on the execution of the location tracker 1171, by using data obtained using an external camera (e.g., image sensor 1121) and/or an IMU (e.g., the motion sensor 1122 including at least one of a gyro sensor, an acceleration sensor and/or a geomagnetic sensor). The location tracker 1171 may be referred to as a head tracking (HeT) module (or a head tracker or head tracking program).

For example, the electronic device 101 may obtain information for providing a three-dimensional virtual space corresponding to a surrounding environment (e.g., external space) of the electronic device 101 (or a user of the electronic device 101), based on the execution of the space recognizer 1172. The electronic device 101 may reproduce the surrounding environment of the electronic device 101 in three dimensions, by using data obtained using an external camera (e.g., image sensor 1121) based on the execution of the space recognizer 1172. The electronic device 101 may identify at least one of a plane, an inclination, and a step, based on the surrounding environment of the electronic device 101 reproduced in three dimensions based on the execution of the space recognizer 1172. The space recognizer 1172 may be referred to as a scene understanding (SU) module (or a scene recognition program).

For example, the electronic device 101 may identify (or recognize) a hand's pose and/or gesture of the user of the electronic device 101 based on the execution of the gesture tracker 1173. For example, the electronic device 101 may identify a pose and/or a gesture of the user's hand by using data obtained from an external camera (e.g., the image sensor 1121), based on the execution of the gesture tracker 1173. As an example, the electronic device 101 may identify a pose and/or a gesture of the user's hand, based on data (or image) obtained using an external camera based on the execution of the gesture tracker 1173. The gesture tracker 1173 may be referred to as a hand tracking (HaT) module (or a hand tracking program) and/or a gesture tracking module.

For example, the electronic device 101 may identify (or track) the movement of the user's eyes of the electronic device 101, based on the execution of the gaze tracker 1174. For example, the electronic device 101 may identify the movement of the user's eyes, by using data obtained from a gaze tracking camera (e.g., the image sensor) based on the execution of the gaze tracker 1174. The gaze tracker 1174 may be referred to as an eye tracking (ET) module (or eye tracking program) and/or a gaze tracking module.

For example, the perception service layer 1170 of the electronic device 101 may further include the face tracker 1175 for tracking the user's face. For example, the electronic device 101 may identify (or track) the movement of the user's face and/or the user's facial expression, based on the execution of the face tracker 1175. The electronic device 101 may estimate the user's facial expression, based on the movement of the user's face based on the execution of the face tracker 1175. For example, the electronic device 101 may identify the movement of the user's face and/or the user's facial expression, based on data (e.g., an image and/or a video) obtained using a camera (e.g., a camera facing at least a portion of the user's face), based on the execution of the face tracker 1175.

Referring to FIG. 11, a renderer 1190 may include instructions for rendering images in a three-dimensional virtual space. The processor 1110 executing the renderer 1190 may obtain at least one image to be at least partially displayed on a display area of the display 230 at a software application. For example, the processor 1110 executing the renderer 1190 may determine a location of an area to which an application (e.g., X R application 1142, application 1145) is to be rendered. The processor 1110 executing the renderer 1190 may create an image of the application to be displayed on the display 230. The renderer 1190 may synthesize the images to create a composite image to be displayed on the display 230.

For example, the processor 1110 executing the renderer 1190 may divide a display area of the display 230 into a foveated portion (or may be referred to as a foveated area) and a peripheral portion (or may be referred to as a remaining area), by using a gaze location calculated using the location tracker 1171 and/or the gaze tracker 1174. For example, the processor 1110 detecting coordinate values of the gaze location may determine a portion of the display area including the coordinate values as a foveated area. The processor 1110 executing the renderer 1190 may obtain at least one image, corresponding to each of the foveated area and the remaining area, and having a size smaller than a size of the entire display area of the display 230 or a resolution less than a resolution of the display area.

The processor 1110 executing the renderer 1190 may obtain or create a composite image to be displayed on the display 230, by synthesizing an image corresponding to the foveated area and an image corresponding to a peripheral portion. For example, the processor 1110 may enlarge the image corresponding to the peripheral portion to a size of the entire display area of the display 230, by performing upscaling. The processor 1110 may create a composite image to be displayed on the display 230, by combine the image corresponding to the foveated area onto the enlarged image. The processor 1110 may mix the enlarged image and the image corresponding to the foveated area, by applying a visual effect such as blur along a boundary line of the image corresponding to the foveated area.

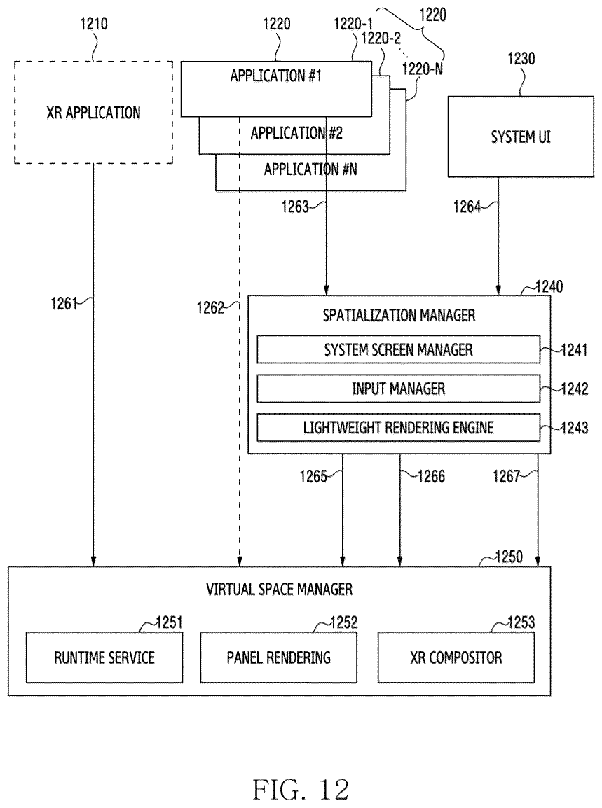

FIG. 12 illustrates an example of a block diagram of an electronic device (e.g., the electronic device 101 of FIGS. 1A to 11) for displaying an image in a virtual space. FIG. 12 describes an example in which a plurality of programs/instructions for displaying an image in a virtual space is executed. The plurality of programs/instructions may all be executed in one processor (e.g., AP) or may be executed by a plurality of processors (e.g., AP, graphic processing unit (GPU), neural processing unit (NPU)). The meaning of being executable by the plurality of processors may indicate that a portion of programs/instructions may be executed by a first processor, and another portion of programs/instructions may be executed by a second processor different from the first processor.

Referring to FIG. 12, the electronic device 101 may execute a virtual space manager 1250 (e.g., the virtual space manager 1151 and the CPM of FIG. 11) to render an image in a virtual space. For the virtual space manager 1250, descriptions of the virtual space manager 1151 of FIG. 11 may be at least partially referenced. The virtual space manager 1250 may include a platform for supporting a virtual space service. The virtual space manager 1250 may include a runtime service 1251 (e.g., OpenXR Runtime), a panel renderer 1252 (e.g., 2D Panel Render), and an X R compositor 1253. The electronic device 101 may execute at least one of a user's pose prediction function, a frame timing function, and/or a space input function, based on the execution of the runtime service 1251. For the runtime service 1251, descriptions of the runtime service 1152 of FIG. 11 may be at least partially referenced. The electronic device 101 may display at least one image (video) on a panel (e.g., a 2D panel) to implement a virtual space through a display, based on the execution of the panel rendering 1252. For example, the electronic device 101 may display a rendering image corresponding to RGB information 1266 for a panel from a spatialization manager 1240 to be described later via a display (e.g., display 230).

According to an embodiment, the electronic device 101 may synthesize an image of an actual area captured through a camera in a virtual space (hereinafter, a pass-through image) and a virtual area image, based on the execution of the X R compositor 1253. For example, the electronic device 101 may create a composite image, by merging the pass-through image and the virtual area image, based on the execution of the X R compositor 1253. The electronic device 101 may transmit the created composite image to a display buffer so that the composite image is displayed. The electronic device 101 may identify the virtual space through the virtual space manager 1250, and display at least a portion of the virtual space on the display 230. The virtual space manager 1250 may be referred to as the CPM. The electronic device 101 may execute the virtual space manager 1250 to render an image corresponding to at least a portion of the virtual space.

According to an embodiment, the electronic device 101 may execute the spatialization manager 1240. The spatialization manager 1240 may perform processes for displaying an image in a three-dimensional virtual space. The electronic device 101 may perform preprocessing based on the execution of the spatialization manager 1240 so that an image may be rendered in a three-dimensional virtual space through the virtual space manager 1250. For example, the electronic device 101 may perform at least some of functions of the renderer 1190 of FIG. 11, based on the execution of the spatialization manager 1240. Based on the execution of the spatialization manager 1240, the electronic device 101 may process image information provided by an application (e.g., the X R application 1210, an application providing a normal two-dimensional screen other than X R, and an application that provides a system UI 1230). The spatialization manager 1240 (e.g., Space Flinger) may include a system screen manager 1241 (e.g., System scene), an input manager 1242 (e.g., Input Routing), and a lightweight rendering engine 1243 (e.g., Impress Engine). The system screen manager 1241 may be executed to display the system UI 1230. System UI-related information 1264 may be transmitted from a program (e.g., A PI) providing the system UI 1230 to the system screen manager 1241. The system UI-related information 1264 may be obtained via a spatializer API and/or a Same-process private API. The spatialization manager 1240 may determine a layout (e.g., location, display order) of a screen of the system UI 1230 in a three-dimensional space, through pre-allocated resources. The system screen manager 1241 may transmit image information 1267 for rendering a screen of the system UI 1230 to the virtual space manager 1250, according to the layout. The input manager 1242 may be configured to process a user input (e.g., user input on a system screen or an app screen). The impress engine 1243 may be a renderer (e.g., the lightweight renderer 1143) for creating an image. For example, the impress engine 1243 may be used to display the system UI 1230. According to an embodiment, the spatialization manager 1240 may include the lightweight rendering engine 1243 for rendering the system UI. According to an embodiment, in a case that the lightweight rendering engine 1243 does not have enough resources to render an avatar used in the HMD, at least one external rendering engine may be used. In this case, in order to solve the compatibility issue with external rendering (e.g., 3rd party engine), an external rendering engine support module may be added inside the spatialization manager 1240.

According to an embodiment, the electronic device may execute an application. For example, the virtual space manager 1250 may be executed in response to the execution of the X R application 1210 (e.g., the XR application 1142, 3D game, XR map, and other immersive application). The electronic device 101 may provide the virtual space manager 1250 with double image information 1261 provided from the X R application 1210. In order to display an image in a three-dimensional space, the double image information 1261 may include two image information considering binocular disparity. For example, the double image information 1261 may include first image information for the user's left eye and second image information for the user's right eye for rendering in a three-dimensional virtual space. Hereinafter, in the present disclosure, double image information is used as a term referring to image information for indicating images for two eyes in a three-dimensional space. In addition to the double image information, binocular image information, double image information, double image data, double image, binocular image data, stereoscopic image information, 3D image information, spatial image information, spatial image data, 2D-3D conversion data, dimensional conversion image data, binocular disparity image data, and/or equivalent technical terms may be used. The electronic device 101 may create a composite image by merging image layers via the virtual space manager 1250. The electronic device 101 may transmit the created composite image to a display buffer. The composite image may be displayed on the display 230 of the electronic device 101.

According to an embodiment, the electronic device may execute at least one of an application 1220 (e.g., first application 1220-1, second application 1220-2, . . . , and Nth application 1220—N) different from the XR application 1210. According to an embodiment, the application 1220 may be configured to output image information for displaying a two-dimensional image. In other words, the application 1220 may provide a two-dimensional image. As an example, the application 1220 may be an image application, a schedule application, or an Internet browser application. If, in response to the execution of the application 1220, image information 1262 provided from the application 1220 is provided to the virtual space manager 1250. Since the image information 1262 has only the x-coordinate and y-coordinate in the two-dimensional plane, it may be difficult to consider the order of precedence (i.e., a distance separated from the user) between other applications centered on the user. Even when displaying the application 1220 providing a general 2D screen, the electronic device 101 may execute the spatialization manager 1240 to provide double image information to the virtual space manager 1250. For example, the electronic device 101 may receive application-related information 1263 from the first application 1220-1, based on the execution of the spatialization manager 1240. For example, the application-related information 1263 may include image information (e.g., information including RGB per pixel) indicating a two-dimensional image of the first application 1220-1 and/or content information (e.g., characteristic of content executed in the first application, type of content) in the first application 1220-1. The application-related information 1263 may be obtained through a spatializer API. Based on the execution of the spatialization manager 1240, the electronic device 101 may identify a location of an area in which the first application 1220-1 is to be rendered and information (hereinafter, location information) on a size of the area to be rendered. Based on the execution of the spatialization manager 1240, the electronic device 101 may create double image information 1265 (e.g., RGB×2) in which the user's binocular disparity is considered, through the image information and the location information. Based on the execution of the spatialization manager 1240, the electronic device 101 may provide the double image information 1265 to the virtual space manager 1250. By converting a simple two-dimensional image into the double image information 1265, a problem occurring when the image information 1262 is directly transmitted to the virtual space manager 1250 may be solved. In addition, as at least some of functions for image display in a virtual space are performed by the spatialization manager 1240 instead of the virtual space manager 1250, the burden on the virtual space manager 1250 may be reduced.

In an embodiment, a method of storing a depth value for three-dimensional rendering of a two-dimensional image by using an alpha channel may be required. As described above, according to an embodiment, an electronic device may include memory (including one or more storage media and/or) storing instructions, and at least one processor including processing circuitry. The instructions, when executed by the at least one processor individually or collectively, may cause the electronic device to obtain depth information of a visual object. The instructions, when executed by the at least one processor individually or collectively, may cause the electronic device to, using the depth information, identify depth values to be included in an alpha channel representing a transparency of the visual object. The instructions, when executed by the at least one processor individually or collectively, may cause the electronic device to generate an image representing the visual object of which the depth values and transparencies are respectively included in the alpha channel of pixels.

For example, the instructions, when executed by the at least one processor individually or collectively, may cause the electronic device to identify a range of the depth values. The instructions, when executed by the at least one processor individually or collectively, may cause the electronic device to, according to the range, determine a bit number to be occupied to represent the depth values in the alpha channel, and a bit number to be occupied to represent the transparencies. The instructions, when executed by the at least one processor individually or collectively, may cause the electronic device to, according to the determination, generate the image including the depth values and the transparencies in the alpha channel.

For example, the instructions, when executed by the at least one processor individually or collectively, may cause the electronic device to, based on determining that the depth values are represented by bits of a first bit number, generate the image including, the depth values represented by the bits of the first bit number using the depth information, and the transparencies represented by bits of a second bit number subtracted from a total number of bits included in the alpha channel by the first bit number. The instructions, when executed by the at least one processor individually or collectively, may cause the electronic device to, based on determining that the depth values are represented by bits of a third bit number greater than the first bit number, generate the image including, the depth values represented by the bits of the third bit number using the depth information, and the transparencies represented by bits of a fourth bit number subtracted from the total number by the third bit number.

For example, a bit sequence indicating a depth value in the alpha channel of each of the pixels may be positioned after a LSB of a bit sequence indicating the transparency in the alpha channel.

For example, a bit sequence indicating a depth value in the alpha channel of each of the pixels may be positioned before a MSB of a bit sequence indicating the transparency in the alpha channel.

For example, the instructions, when executed by the at least one processor individually or collectively, may cause the electronic device to generate metadata indicating a bit number in the alpha channel reserved for indicating each of the depth values. The instructions, when executed by the at least one processor individually or collectively, may cause the electronic device to generate a file including the metadata and the image.

For example, the instructions, when executed by the at least one processor individually or collectively, may cause the electronic device to, while generating the image including a first area corresponding to the visual object, and a second area surrounding the first area, in the alpha channel of pixels corresponding to the first area, insert the depth values and the transparencies. The instructions, when executed by the at least one processor individually or collectively, may cause the electronic device to, in pixels corresponding to the second area, insert bit numbers of the depth values which are inserted in the alpha channel of the pixels corresponding to the first area.

For example, the instructions, when executed by the at least one processor individually or collectively, may cause the electronic device to, based on generating a video including the image which is a first image, obtain other depth information based on a shape of the visual object at a second moment after a first moment corresponding to the first image. The instructions, when executed by the at least one processor individually or collectively, may cause the electronic device to generate a second image of which difference values between depth values indicated by the other depth information, and the depth values included in the alpha channel of the first image are respectively included in an alpha channel of pixels. The instructions, when executed by the at least one processor individually or collectively, may cause the electronic device to generate the video including the first image and the second image.

For example, the instructions, when executed by the at least one processor individually or collectively, may cause the electronic device to, based on generating the first image corresponding to a key frame within the video, based on generating at least one image corresponding to a time section with a preset length associated with the key frame from the first moment corresponding to the first image, generate the at least one image of which difference values with respect to the depth values included in the alpha channel of the first image are respectively included in the alpha channel of pixels.

For example, the instructions, when executed by the at least one processor individually or collectively, may cause the electronic device to, based on generating a video including the image which is a first image, based on a preset number of images which are rendered after the first image corresponding to a key frame within the video, generate the preset number of images of which difference values with respect to the depth values included in the alpha channel of the first image are respectively included in the alpha channel of pixels.

For example, the instructions, when executed by the at least one processor individually or collectively, may cause the electronic device to, based on generating a video including the image which is a first image, obtain other depth information associated with the visual object at a second moment after a first moment corresponding to the first image. The instructions, when executed by the at least one processor individually or collectively, may cause the electronic device to obtain difference values between depth values included in an alpha channel of the pixels of the first image which are indicated by the depth information, and other depth values respectively corresponding to pixels of a second image corresponding to the second moment indicated by the other depth information. The instructions, when executed by the at least one processor individually or collectively, may cause the electronic device to, based on obtaining the difference values included in a reference range, generate the second image of which the difference values are respectively included in the alpha channel of the pixels. The instructions, when executed by the at least one processor individually or collectively, may cause the electronic device to, based on obtaining the difference values outside the reference range, generate the second image of which the other depth values and transparencies are respectively included in the alpha channel of the pixels.

For example, the electronic device may include a sensor configured to detect a motion of a user. The instructions, when executed by the at least one processor individually or collectively, may cause the electronic device to, based on generating a video including the image which is a first image which represents the visual object moved according to the motion detected by the sensor, obtain the depth information used to generate the first image using sensor data detected from the sensor at a first moment. The instructions, when executed by the at least one processor individually or collectively, may cause the electronic device to detect sensor data from the sensor at a second moment after the first moment. The instructions, when executed by the at least one processor individually or collectively, may cause the electronic device to identify a difference between the sensor data detected at the first moment and the sensor data detected at the second moment. The instructions, when executed by the at least one processor individually or collectively, may cause the electronic device to, based on identifying the difference included in a reference range, generate a second image corresponding to the second moment of which difference values between the depth values included in the alpha channel of the first image, and other depth values indicated by other depth information obtained based on the sensor data at the second moment are respectively included in an alpha channel of pixels. The instructions, when executed by the at least one processor individually or collectively, may cause the electronic device to, based on identifying the difference outside the reference range, generate the second image corresponding to the second moment of which the other depth values are respectively included in the alpha channel of the pixels.

For example, the electronic device may include a display assembly including a plurality of displays. The instructions, when executed by the at least one processor individually or collectively, may cause the electronic device to receive an input to display the image. The instructions, when executed by the at least one processor individually or collectively, may cause the electronic device to, based on the input, obtain the depth values included in the alpha channel of the pixels of the image. The instructions, when executed by the at least one processor individually or collectively, may cause the electronic device to, based on the obtained depth values, determine a binocular parallax of each of the pixels. The instructions, when executed by the at least one processor individually or collectively, may cause the electronic device to, based on the binocular parallax, display the image on a first display among the plurality of displays. The instructions, when executed by the at least one processor individually or collectively, may cause the electronic device to display another image representing the visual object shifted based on the binocular parallax on a second display among the plurality of displays.

For example, the visual object may include an avatar representing a user of the electronic device.

For example, the instructions, when executed by the at least one processor individually or collectively, may cause the electronic device to, based on receiving an input to render the avatar, start to generate the image using a virtual space including the avatar.

As described above, according to an embodiment, a method of an electronic device may be provided. The method may include obtaining depth information of a visual object. The method may include, using the depth information, identifying depth values to be included in an alpha channel representing a transparency of the visual object. The method may include generating an image representing the visual object of which the depth values and transparencies are respectively included in the alpha channel of pixels.

For example, the identifying may include identifying a range of the depth values. The method may include, according to the range, determining a bit number to be occupied to represent the depth values in the alpha channel, and a bit number to be occupied to represent the transparencies. The generating may include, according to the determination, generating the image including the depth values and the transparencies in the alpha channel.

For example, the generating may include, based on determining that the depth values are represented by bits of a first bit number, generating the image including the depth values represented by the bits of the first bit number using the depth information, and the transparencies represented by bits of a second bit number subtracted from a total number of bits included in the alpha channel by the first bit number. The method may include, based on determining that the depth values are represented by bits of a third bit number greater than the first bit number, generating the image including the depth values represented by the bits of the third bit number using the depth information, and the transparencies represented by bits of a fourth bit number subtracted from the total number by the third bit number.

For example, a bit sequence indicating a depth value in the alpha channel of each of the pixels may be positioned after a LSB of a bit sequence indicating the transparency in the alpha channel.

For example, a bit sequence indicating a depth value in the alpha channel of each of the pixels may be positioned before a MSB of a bit sequence indicating the transparency in the alpha channel.

For example, the generating may include generating metadata indicating a bit number in the alpha channel reserved for indicating each of the depth values. The method may include generating a file including the metadata and the image.

For example, the generating may include, while generating the image including a first area corresponding to the visual object, and a second area surrounding the first area, in the alpha channel of pixels corresponding to the first area, inserting the depth values and the transparencies. The method may include inserting, in pixels corresponding to the second area, bit numbers of the depth values which are inserted in the alpha channel of the pixels corresponding to the first area.

For example, the method may include generating a video including the image which is a first image. The generating the video may include obtaining other depth information based on a shape of the visual object at a second moment after a first moment corresponding to the first image. The method may include generating a second image of which difference values between depth values indicated by the other depth information, and the depth values included in the alpha channel of the first image are respectively included in an alpha channel of pixels. The method may include generating the video including the first image and the second image.

For example, the generating the video may include, based on generating the first image corresponding to a key frame within the video, based on generating at least one image corresponding to a time section with a preset length associated with the key frame from the first moment corresponding to the first image, generating the at least one image of which difference values with respect to the depth values included in the alpha channel of the first image are respectively included in the alpha channel of pixels.

For example, the method may include generating a video including the image which is a first image. The generating the video may include, based on a preset number of images which are rendered after the first image corresponding to a key frame within the video, generating the preset number of images of which the depth values included in the alpha channel of the first image are respectively included in the alpha channel of pixels.

For example, the method may include generating a video including the image which is a first image. The generating the video may include obtaining other depth information associated with the visual object at a second moment after a first moment corresponding to the first image. The method may include obtaining difference values between depth values included in an alpha channel of the pixels of the first image which are indicated by the depth information, and other depth values respectively corresponding to pixels of a second image corresponding to the second moment indicated by the other depth information. The method may include, based on obtaining the difference values included in a reference range, generating the second image of which the difference values are respectively included in the alpha channel of the pixels. The method may include, based on obtaining the difference values outside of the reference range, generating the second image of which the other depth values and transparencies are respectively included in the alpha channel of the pixels.

For example, the method may include generating a video including the image which is a first image which represents the visual object moved according to a motion detected by a sensor configured to detect the motion of a user. The generating the video may include obtaining the depth information used to generate the first image using sensor data detected from the sensor at a first moment. The method may include detecting sensor data from the sensor at a second moment after the first moment. The method may include identifying a difference between the sensor data detected at the first moment and the sensor data detected at the second moment. The method may include, based on identifying the difference included in a reference range, generating a second image corresponding to the second moment of which difference values between the depth values included in the alpha channel of the first image, and other depth values indicated by other depth information obtained based on the sensor data at the second moment are respectively included in an alpha channel of pixels. The method may include, based on identifying the difference outside the reference range, generating the second image corresponding to the second moment of which the other depth values are respectively included in the alpha channel of the pixels.

For example, the method may include, when performed by the electronic device further including a display assembly including a plurality of displays, receiving an input to display the image. The method may include, based on the input, obtaining the depth values included in the alpha channel of the pixels of the image. The method may include, based on the obtained depth values, determining a binocular parallax of each of the pixels. The method may include, based on the binocular parallax, displaying the image on a first display among the plurality of displays. The method may further comprise displaying another image representing the visual object shifted based on the binocular parallax on a second display among the plurality of displays.

For example, the visual object may include an avatar representing a user of the electronic device.

For example, the generating the image may be started by using a virtual space including the avatar in response to receiving an input to render the avatar.

As described above, according to an embodiment, a non-transitory computer readable storage medium storing instructions may be provided. The instructions, when executed by an electronic device including a display assembly including a plurality of displays, may cause the electronic device to obtain a file including an image representing a visual object. The instructions, when executed by the electronic device, may cause the electronic device to identify, from an alpha channel of pixels of the image, depth values and transparencies of portions of the visual object respectively corresponding to the pixels. The instructions, when executed by the electronic device, may cause the electronic device to, while controlling the display assembly to display the visual object represented based on the transparencies, control the plurality of displays such that the portions displayed on a first display of the plurality of displays are respectively shifted from the portions displayed on a second display of the plurality of displays according to the depth values.

As described above, according to an embodiment, an electronic device may include a display assembly including a plurality of displays, memory storing instructions and including one or more storage mediums, and at least one processor including processing circuitry. The instructions, when executed by the at least one processor individually or collectively, may cause the electronic device to obtain a file including an image representing a visual object. The instructions, when executed by the at least one processor individually or collectively, may cause the electronic device to identify, from an alpha channel of pixels of the image, depth values and transparencies of portions of the visual object respectively corresponding to the pixels. The instructions, when executed by the at least one processor individually or collectively, may cause the electronic device to, while controlling the display assembly to display the visual object represented based on the transparencies, control the plurality of displays such that the portions displayed on a first display of the plurality of displays are respectively shifted from the portions displayed on a second display of the plurality of displays according to the depth values.

According to an aspect of the disclosure, an electronic device includes: memory comprising one or more storage media storing instructions; and at least one processor comprising processing circuitry, wherein the instructions, when executed by the at least one processor individually or collectively, cause the electronic device to: obtain depth information of a visual object, identify, based on the depth information of the visual object, depth values, add the depth values to an alpha channel of an image representing the visual object, and generate the image, and wherein the alpha channel includes the depth values and transparencies of the visual object.

The instructions, when executed by the at least one processor individually or collectively, may further cause the electronic device to: identify a range of the depth values, based on the range of the depth values, determine a first bit number representing the depth values in the alpha channel, and a second bit number representing the transparencies, and based on the determined first bit number and the determined second bit number, generate the image.

In a first case that the depth values are represented by first bits of the first bit number, the first bits being determined using the depth information, the transparencies may be represented by second bits of the second bit number, which are subtracted from a total number of bits in the alpha channel by the first bits of the first bit number, and wherein, in a second case that the depth values are represented by third bits of a third bit number that is greater than the first bit number, the third bits being determined using the depth information, the transparencies may be represented by fourth bits of a fourth bit number, which are subtracted from the total number of bits in the alpha channel by the third bits of the third bit number.

A first bit sequence indicating the depth values in the alpha channel may be positioned after a least significant bit (L SB) of a second bit sequence indicating the transparencies in the alpha channel.

A first bit sequence indicating the depth values in the alpha channel may be positioned before a most significant bit (M SB) of a second bit sequence indicating the transparencies in the alpha channel.

The instructions, when executed by the at least one processor individually or collectively, may further cause the electronic device to: generate metadata indicating a bit number in the alpha channel, the metadata being reserved for indicating the depth values, and generate a file including the metadata and the image.

The image may include a first area corresponding to the visual object and a second area surrounding the first area, wherein the instructions, when executed by the at least one processor individually or collectively, may further cause the electronic device to: insert, in first pixels of the alpha channel, the depth values and the transparencies, and insert, in second pixels of the alpha channel, bit numbers of the depth values inserted in the first pixels, and wherein the first pixels correspond to the first area and the second pixels correspond to the second area.

The image may be a first image, and wherein the instructions, when executed by the at least one processor individually or collectively, may further cause the electronic device to: obtain other depth information based on a shape of the visual object at a second moment after a first moment corresponding to the first image, generate a second image having the alpha channel including differences between other depth values indicated by the other depth information and the depth values in the alpha channel of the first image, and generate a video including the first image and the second image.

The instructions, when executed by the at least one processor individually or collectively, may further cause the electronic device to, based on generating the first image corresponding to a key frame within the video, based on generating at least one image corresponding to a time section with a preset length associated with the key frame from the first moment corresponding to the first image, generate the at least one image having the alpha channel including difference values with respect to the depth values in the alpha channel of the first image.

The image may be a first image, and wherein the instructions, when executed by the at least one processor individually or collectively, may further cause the electronic device to, based on a preset number of images which are rendered after the first image corresponding to a key frame within a video, generate the preset number of images including the alpha channel including difference values with respect to the depth values in the alpha channel of the first image.

The image may be a first image, and wherein the instructions, when executed by the at least one processor individually or collectively, may further cause the electronic device to: obtain other depth information associated with the visual object at a second moment after a first moment corresponding to the first image, obtain difference values between depth values in the alpha channel of the first image, which are indicated by the depth information, and other depth values respectively corresponding to a second image corresponding to the second moment indicated by the other depth information, based on obtaining the difference values in a reference range, generate the second image having the alpha channel including the difference values, and based on obtaining the difference values outside the reference range, generate the second image having the alpha channel including the other depth values and the other transparencies.

The electronic device may further include a sensor configured to detect a motion of a user, wherein the image is a first image which represents the visual object moved based on the motion detected by the sensor, and wherein the instructions, when executed by the at least one processor individually or collectively, may further cause the electronic device to: obtain the depth information to generate the first image using first sensor data detected from the sensor at a first moment, detect second sensor data from the sensor at a second moment after the first moment, identify a difference between the first sensor data detected at the first moment and the second sensor data detected at the second moment, based on identifying that the difference is within a reference range, generate a second image corresponding to the second moment, wherein the alpha channel of the second image includes difference values between the depth values included in the alpha channel of the first image, and other depth values indicated by other depth information obtained based on the sensor data at the second moment, and based on identifying that the difference is outside the reference range, generate the second image corresponding to the second moment, wherein the alpha channel of the second image includes the other depth values.

The electronic device may further include a display assembly including a plurality of displays, wherein the instructions, when executed by the at least one processor individually or collectively, may further cause the electronic device to: receive an input to display the image, based on the input, obtain the depth values in the alpha channel of the image, based on the obtained depth values, determine a binocular parallax of the alpha channel, based on the binocular parallax, display the image on a first display among the plurality of displays, and based on the binocular parallax, display another image representing the visual object shifted based on the binocular parallax on a second display among the plurality of displays.

The visual object may include an avatar representing a user of the electronic device.

The instructions, when executed by the at least one processor individually or collectively, may further cause the electronic device to, based on receiving an input to render the avatar, start to generate the image using a virtual space including the avatar.

According to an aspect of the disclosure, a method of an electronic device, includes: obtaining depth information of a visual object; identifying, using the depth information, depth values; adding the depth values to an alpha channel of an image representing the visual object, and generating the image, wherein the alpha channel includes the depth values and transparencies of the visual object.

The identifying, based on the depth information of the visual object, depth values, may include: identifying a range of the depth values, determining, based on the range of the depth values, a first bit number to represent the depth values in the alpha channel, and a second bit number to represent the transparencies in the alpha channel, and wherein the generating the image includes generating the image based on the determined first number and the determined second number.

In a first case that the depth values are represented by first bits of the first bit number, the first bits being determined using the depth information, the transparencies may be represented by second bits of the second bit number, which are subtracted from a total number of bits in the alpha channel by the first bits of the first bit number, and wherein, in a second case that the depth values are represented by third bits of a third bit number greater than the first bit number, the third bits of the third being determined using the depth information, the transparencies may be represented by fourth bits of a fourth bit number, which are subtracted from the total number of bits in the alpha channel by the third bits of the third bit number.

A first bit sequence indicating the depth values in the alpha channel may be positioned after a least significant bit (L SB) of a second bit sequence indicating the transparencies in the alpha channel.

A first bit sequence indicating the depth values in the alpha channel may be positioned before a most significant bit (MSB) of a second bit sequence indicating the transparencies in the alpha channel.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. There is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

According to the embodiment, the method may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

What is claimed is:

1. An electronic device comprising:
memory comprising one or more storage media storing instructions; and
at least one processor comprising processing circuitry,
wherein the instructions, when executed by the at least one processor individually or collectively, cause the electronic device to:
obtain depth information of a visual object,
identify, based on the depth information of the visual object, depth values,
add the depth values to an alpha channel of an image representing the visual object, and
generate the image, and
wherein the alpha channel comprises the depth values and transparencies of the visual object.

2. The electronic device of claim 1, wherein the instructions, when executed by the at least one processor individually or collectively, further cause the electronic device to:
identify a range of the depth values,
determine, based on the range of the depth values, a first bit number representing the depth values in the alpha channel, and a second bit number representing the transparencies, and
generate, based on the determined first bit number and the determined second bit number, the image.

3. The electronic device of claim 2, wherein, in a first case that the depth values are represented by first bits of the first bit number, the first bits being determined using the depth information, the transparencies are represented by second bits of the second bit number, which are subtracted from a total number of bits in the alpha channel by the first bits of the first bit number, and
wherein, in a second case that the depth values are represented by third bits of a third bit number that is greater than the first bit number, the third bits being determined using the depth information, the transparencies are represented by fourth bits of a fourth bit number, which are subtracted from the total number of bits in the alpha channel by the third bits of the third bit number.

4. The electronic device of claim 1, wherein a first bit sequence indicating the depth values in the alpha channel is positioned after a least significant bit (L SB) of a second bit sequence indicating the transparencies in the alpha channel.

5. The electronic device of claim 1, wherein a first bit sequence indicating the depth values in the alpha channel is positioned before a most significant bit (MSB) of a second bit sequence indicating the transparencies in the alpha channel.

6. The electronic device of claim 1, wherein the instructions, when executed by the at least one processor individually or collectively, further cause the electronic device to:
generate metadata indicating a bit number in the alpha channel, the metadata being reserved for indicating the depth values, and
generate a file comprising the metadata and the image.

7. The electronic device of claim 1, wherein the image comprises a first area corresponding to the visual object and a second area surrounding the first area,
wherein the instructions, when executed by the at least one processor individually or collectively, further cause the electronic device to:
insert, in first pixels of the alpha channel, the depth values and the transparencies, and
insert, in second pixels of the alpha channel, bit numbers of the depth values inserted in the first pixels, and
wherein the first pixels correspond to the first area and the second pixels correspond to the second area.

8. The electronic device of claim 1, wherein the image is a first image, and
wherein the instructions, when executed by the at least one processor individually or collectively, further cause the electronic device to:
obtain other depth information based on a shape of the visual object at a second moment after a first moment corresponding to the first image,
generate a second image having the alpha channel comprising differences between other depth values indicated by the other depth information and the depth values in the alpha channel of the first image, and
generate a video comprising the first image and the second image.

9. The electronic device of claim 8, wherein the instructions, when executed by the at least one processor individually or collectively, further cause the electronic device to, based on generating the first image corresponding to a key frame within the video, based on generating at least one image corresponding to a time section with a preset length associated with the key frame from the first moment corresponding to the first image, generate the at least one image having the alpha channel comprising difference values with respect to the depth values in the alpha channel of the first image.

10. The electronic device of claim 1, wherein the image is a first image, and
wherein the instructions, when executed by the at least one processor individually or collectively, further cause the electronic device to, based on a preset number of images which are rendered after the first image corresponding to a key frame within a video, generate the preset number of images comprising the alpha channel comprising difference values with respect to the depth values in the alpha channel of the first image.

11. The electronic device of claim 1, wherein the image is a first image, and
wherein the instructions, when executed by the at least one processor individually or collectively, further cause the electronic device to:
obtain other depth information associated with the visual object at a second moment after a first moment corresponding to the first image,
obtain difference values between depth values in the alpha channel of the first image, which are indicated by the depth information, and other depth values respectively corresponding to a second image corresponding to the second moment indicated by the other depth information,
based on obtaining the difference values in a reference range, generate the second image having the alpha channel comprising the difference values, and
based on obtaining the difference values outside the reference range, generate the second image having the alpha channel comprising the other depth values and the other transparencies.

12. The electronic device of claim 1, further comprises a sensor configured to detect a motion of a user,
wherein the image is a first image which represents the visual object moved based on the motion detected by the sensor, and
wherein the instructions, when executed by the at least one processor individually or collectively, further cause the electronic device to:
obtain the depth information to generate the first image using first sensor data detected from the sensor at a first moment,
detect second sensor data from the sensor at a second moment after the first moment, identify a difference between the first sensor data detected at the first moment and the second sensor data detected at the second moment,
based on identifying that the difference is within a reference range, generate a second image corresponding to the second moment, wherein the alpha channel of the second image comprises difference values between the depth values included in the alpha channel of the first image, and other depth values indicated by other depth information obtained based on the sensor data at the second moment, and
based on identifying that the difference is outside the reference range, generate the second image corresponding to the second moment, wherein the alpha channel of the second image comprises the other depth values.

13. The electronic device of claim 1, further comprises a display assembly comprising a plurality of displays,
wherein the instructions, when executed by the at least one processor individually or collectively, further cause the electronic device to:
receive an input to display the image,
obtain, based on receiving the input, the depth values in the alpha channel of the image,
determine, based on the obtained depth values, a binocular parallax of the alpha channel,
based on the binocular parallax, display the image on a first display among the plurality of displays, and
based on the binocular parallax, display another image representing the visual object shifted based on the binocular parallax on a second display among the plurality of displays.

14. The electronic device of claim 1, wherein the visual object comprises an avatar representing a user of the electronic device.

15. The electronic device of claim 14, wherein the instructions, when executed by the at least one processor individually or collectively, further cause the electronic device to, based on receiving an input to render the avatar, start to generate the image using a virtual space comprising the avatar.

16. A method of an electronic device, the method comprising:
obtaining depth information of a visual object;
identifying, using the depth information, depth values;
adding the depth values to an alpha channel of an image representing the visual object, and
generating the image,
wherein the alpha channel comprises the depth values and transparencies of the visual object.

17. The method of claim 16, wherein the identifying, based on the depth information of the visual object, depth values, comprises:
identifying a range of the depth values,
determining, based on the range of the depth values, a first bit number to represent the depth values in the alpha channel, and a second bit number to represent the transparencies in the alpha channel, and
wherein the generating the image comprises generating the image based on the determined first number and the determined second number.

18. The method of claim 17, wherein, in a first case that the depth values are represented by first bits of the first bit number, the first bits being determined using the depth information, the transparencies are represented by second bits of the second bit number, which are subtracted from a total number of bits in the alpha channel by the first bits of the first bit number, and
wherein, in a second case that the depth values are represented by third bits of a third bit number greater than the first bit number, the third bits being determined using the depth information, the transparencies are represented by fourth bits of a fourth bit number, which are subtracted from the total number of bits in the alpha channel by the third bits of the third bit number.

19. The method of claim 16, wherein a first bit sequence indicating the depth values in the alpha channel is positioned after a least significant bit (LSB) of a second bit sequence indicating the transparencies in the alpha channel.

20. The method of claim 16, wherein a first bit sequence indicating the depth values in the alpha channel is positioned before a most significant bit (MSB) of a second bit sequence indicating the transparencies in the alpha channel.
